(19) United States
(12) Patent Application Publication
(10) Pub. No.: US 2026/0257136 A1
(43) Pub. Date: Sep. 3, 2026

(54) SYSTEMS, METHODS, AND COMPUTER-READABLE MEDIA FOR PROVIDING GAMING ASSISTANCE USING GAMEPLAY MODELS

(71) Applicant: Adeia Guides Inc., San Jose, CA (US)

(72) Inventors: Evgeny Kaminsky, Hollywood, FL (US); Reda Harb, Saint Petersburg, FL (US); Charles Dasher, Lawrenceville, GA (US); Tao Chen, Palo Alto, CA (US)

(21) Appl. No.: 19/067,136

(22) Filed: Feb. 28, 2025

(51) Int. Cl. A63F 13/67; A63F 13/798

(52) U.S. Cl. CPC A63F 13/67; A63F 13/798

(57) ABSTRACT

Systems and methods are described herein for providing in-game video assistance. The system may, while a video game is being played by a first user during a gaming session, determine to provide gameplay assistance to the first user for a portion of the video game. A gameplay model may be selected for importation into the gaming session. The gameplay model may be generated based at least in part on gameplay of a second user determined to have a skill level above a threshold with respect to the video game. The gameplay model may be imported into the gaming session, and the imported gameplay model may be used to predict one or more gameplay actions. While the video game is being played by the first user, gameplay assistance may be output based at least in part on the predicted one or more gameplay actions.

### BACKGROUND

The present disclosure is related to providing in-game assistance in a video game based on an artificial intelligence (AI) model.

### SUMMARY

As video games have become more advanced, they have also become increasingly difficult for players. Many players struggle to progress through challenging levels, defeat formidable opponents, or master complex game mechanics. This can lead to frustration, reduced engagement, additional stress on computing resources and diminished gaming experience.

In one approach, to offer guidance to struggling video game players, a skilled player may create an online video tutorial, or live playthrough, of the skilled player playing a video game, to show others how the skilled player approaches the video game, level, or event. Other players may watch the tutorial or play through to understand how an advanced player approaches a game or get tips for their own progress. Players may then implement what they have learned in their own gameplays, in hopes that it will improve their own performances.

While this approach can be useful, there are a lack of effective mechanisms for a skilled player to share their knowledge in a manner that is personalized and integrated into the gaming experience. For example, tutorials and live playthroughs offer limited interactivity and do not provide real time assistance tailored to an individual player's specific in-game situation.

To help overcome these problems, systems, methods, apparatuses, and computer-readable media are disclosed herein for dynamically providing in-game assistance to a user, based at least in part on importing an AI model trained on gameplay data of a skilled player with respect to the video game. For example, while a video game is being played by a first user during a gaming session, the disclosed techniques may determine to provide gameplay assistance to the first user for a portion of the video game. The disclosed techniques may, based at least in part on the determining, select for importation into the gaming session a gameplay model, wherein the gameplay model is generated based at least in part on gameplay of a second user determined to have a skill level above a threshold with respect to the video game. The disclosed techniques may import the gameplay model into the gaming session, predict one or more gameplay actions based at least in part on the gameplay model, and, while the video game is being played by the first user, cause output of gameplay assistance based at least in part on the predicted one or more gameplay actions.

Such aspects may leverage AI models to glean key insights from the valuable expertise and strategies contained in the gameplay data of skilled players of a video game, to provide real time in-game assistance to less experienced players of the video game in overcoming a challenge, completing a task, and/or winning a match in the video game, without introducing significant delays that impact the user experience. For example, the system may predict that a user playing the video game is likely to experience upcoming gameplay that has yet to occur and prepares such instruction for the player preemptively. To optimize real time assistance, the disclosed system may employ techniques to minimize latency, such as predictive modeling and preprocessing instructions, ensuring that real time assistance does not negatively impact user experience. In some embodiments, the system may employ generative AI to create personalized audio and visual instructions, possibly incorporating the skilled player's voice, enhancing authenticity, immersion and effectiveness of the gameplay assistance.

In some embodiments, the disclosed techniques assist gameplay based on the current state and position of the game and previously successful tactics. In some embodiments, the previously successful tactics are those of known skilled players. The described system may create and train an AI model using the skilled player's or other successful gameplay data to generate a predictive environment. The predictive AI environment is capable of recommending successful actions at a given point in the game based on its training, and may offer successful tactics to players struggling within the game. The disclosed systems and techniques may, in some embodiments, recommend actions to a struggling player while the player is engaged in gameplay, offering immediate in-game support. The recommendations may be based on the current state of gameplay and/or the individual player's performance and preferences. The in-game support therefore also allows for customized suggestions for each individual player's specific situation.

In some embodiments, the disclosed techniques further include determining the second user has a skill level above the threshold with respect to the video game based at least in part on receiving data regarding gameplay of the second user with respect to the video game, and generating the gameplay model by causing training of a machine learning model using the received data.

In some embodiments, the disclosed techniques further include obtaining the predicted one or more gameplay actions for the portion of the video game based at least in part on inputting an indication of a current state of the video game being played by the first user to the trained machine learning model. In some embodiments, the disclosed techniques further include obtaining the predicted one or more gameplay actions for the portion of the video game based at least in part on inputting an indication of a current state of the video game being played by the first user to the trained machine learning model.

In some embodiments, the disclosed techniques further include determining, after causing the output of the gameplay assistance, that one or more inputs received from the first user playing the portion of the video game do not match the one or more inputs associated with the predicted one or more gameplay actions of the second user, identifying an updated state of the video game based at least in part on the one or more inputs received from the first user, and obtaining a new predicted gameplay action based at least in part on inputting an indication of the updated state of the video game being played by the first user to the trained machine learning model.

In some embodiments, the disclosed techniques further use the imported gameplay model to predict one or more gameplay actions by identifying a plurality of candidate predicted gameplay actions, ranking the plurality of candidate gameplay actions based at least in part on similarity to historical actions of the first user with respect to the video game, and identifying the highest ranked one or more gameplay actions as the most likely one or more gameplay actions.

In some embodiments, the disclosed techniques further include implementing a gameplay model that comprises a generative artificial intelligence (AI) model, and using the generative AI model to output the gameplay assistance in a voice of the second user.

In some embodiments, in the disclosed techniques the determining to provide gameplay assistance to the first user for the portion of the video game is performed based on a prediction, prior to the gaming session corresponding to the portion of the video game, that the gaming session is likely to correspond to the portion of the video game within at a later time that is within a threshold period of time from a current time, and importing the gameplay model is preemptively performed prior to the later time.

In some embodiments, the disclosed techniques further include identifying a permission associated with the gameplay model, determining whether the permission indicates that the first user is permitted to modify the gameplay model based at least in part on gameplay of the first user in relation to the video game, and based at least in part on determining the permission permits the first user to modify the gameplay model, fine-tuning the gameplay model based at least in part on gameplay of the first user. In some embodiments, the systems and techniques, further include that the permission is stored on a distributed ledger defining restrictions on modification or redistribution for a plurality of gameplay models.

In some embodiments, the disclosed techniques further include determining whether the gameplay assistance matches one or more inputs received from the first user when the gaming session corresponds to the portion of the video game, determining a level of success of the gameplay assistance, and updating the gameplay model based at least in part on the success of the gameplay assistance.

In some embodiments, the disclosed techniques further include aggregating at least two gameplay models to create a multiplayer gameplay model, and wherein the gaming session comprises at least one additional user other than the first user. For example, different users may correspond to different characters in the game or perform different tasks. The disclosed techniques may use this information to provide individual assistance to the various players. For example, when importing the group model into a multi-player game, the system may determine identities of the game participants along with characters and/or tasks that they are responsible for in the game, to facilitate providing individualized assistance to the various players. In some embodiments, the disclosed techniques further include the gameplay model being trained using data from one or more multi-player gaming sessions of the video game, and wherein the gaming session is a multi-player gaming session. For example, a team can utilize AI models trained on the gameplay of successful groups in multi-player sessions, to leverage collective experience.

The disclosed techniques may enhance the gaming experience by bridging the gap between skilled and less experienced players, fostering a more engaging and supportive gaming community.

In some embodiments, while the gameplay assistance is being provided to the first user, gameplay of the first user is not counted towards an assessment of a skill level of the first user, wherein the skill level of the first user is less than the threshold with respect to the video game.

In some embodiments, the disclosed techniques may recommend activating specific AI models in response to detecting player struggles during critical gameplay moments, to provide dynamic, on-the-fly support.

In some embodiments, the disclosed techniques may allow players to activate different AI models during multiplayer sessions, thereby adopting diverse gameplay styles, introducing a flexible system that customizes in-game strategies to individual player preferences.

In some embodiments, the disclosed techniques may score AI models for their performance on specific games, levels or characters and recommend models to provide a layer of quality control, ensuring players receive meaningful and practical assistance.

### BRIEF DESCRIPTION OF THE DRAWINGS

FIG. 1 shows a system for providing in-game assistance based on a gameplay model, in accordance with some embodiments of the disclosure;

FIG. 2A shows illustrative training of an AI model to obtain a gameplay model for a skilled player of a video game, in accordance with some embodiments of the disclosure;

FIG. 2B shows illustrative use of a trained gameplay to output predicted actions of the skilled player for a portion of a video game being played by another player, in accordance with some embodiments of the disclosure;

FIG. 2C shows sequence diagram of a workflow of AI model creation and sharing, in accordance with some embodiments of the disclosure;

FIG. 3 shows an example workflow in which the gaming assistance system recommends and imports an AI model to a current gaming session, in accordance with some embodiments of the disclosure;

FIG. 4 shows an example workflow of in-game gameplay assistance using an AI model, in accordance with some embodiments of the disclosure;

FIG. 5 shows an alternative embodiments of gameplay assistance using an AI model, in accordance with some embodiments of the disclosure;

FIG. 6 shows an example embodiment of model monetization using a distributed ledger, in accordance with some embodiments of the disclosure;

FIG. 7 shows an example workflow of a multiplayer gaming session using multiple AI models, in accordance with some embodiments of the disclosure;

FIG. 8 shows an example workflow of model recommendation and importation into a gaming session in a group setting, in accordance with some embodiments of the disclosure;

FIG. 9 shows an example workflow of model fine-tuning and redistribution, in accordance with some embodiments of the disclosure;

FIGS. 10-11 show illustrative devices, systems, servers, and related hardware for generating in-game assistance, in accordance with some embodiments of this disclosure; and

FIG. 12 is an illustrative flowchart of a process for providing in-game assistance based on a gameplay model, in accordance with some embodiments of this disclosure.

### DETAILED DESCRIPTION

The present disclosure describes, at least in part, systems and methods for importing (e.g., downloading or otherwise receiving or providing) gaming assistance, provided via an AI model (e.g., a machine learning model), into live gameplay of a video game. In some embodiments, the system may utilize hierarchical neural networks with distributed learning, model exchange mechanisms, and/or a distributed ledger (e.g., blockchain technology) to create a secure and efficient platform for implementing AI-driven gaming assistance.

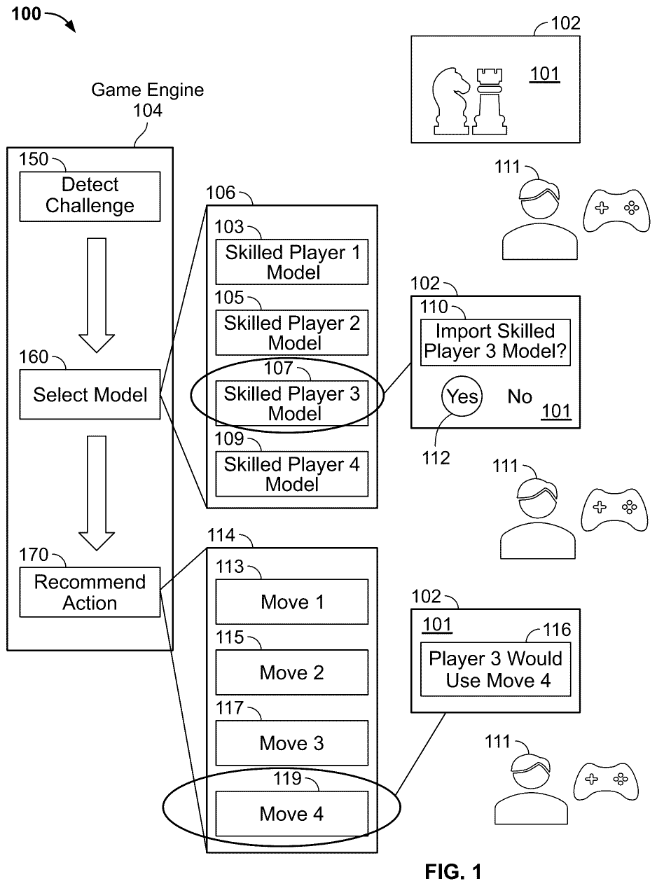

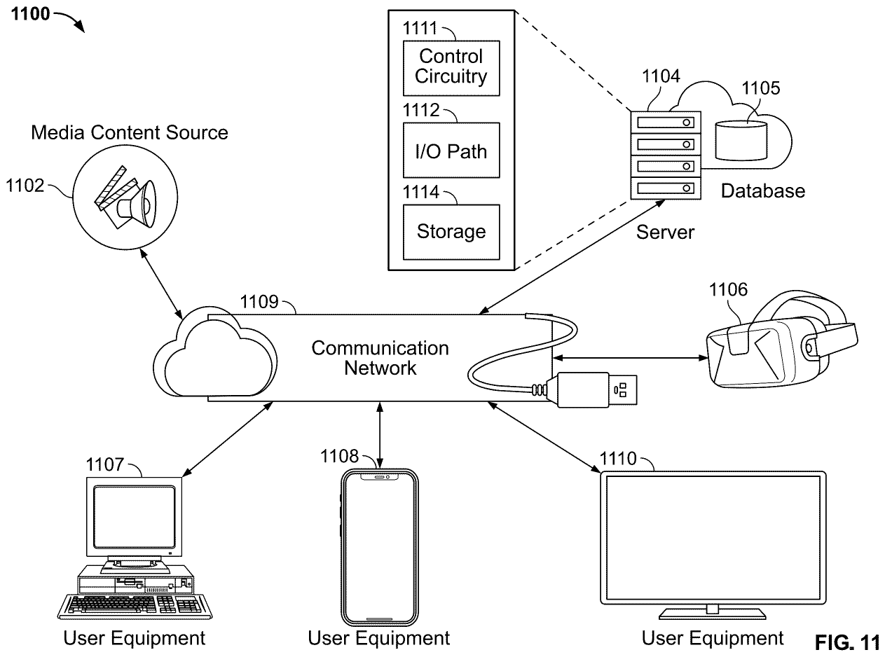

FIG. 1 shows a system for providing in-game assistance based on a gameplay model, in accordance with some embodiments of the disclosure. The techniques shown in FIGS. 1-12 and described herein may be implemented at least in part by gaming assistance system 100. Gaming assistance system 100 comprises any suitable combination of hardware and software, e.g., client devices, game engines, servers, databases (e.g., an AI model repository, a distributed ledger) in communication over one or more communication networks. Gaming assistance system 100 may be executed at least in part at one or more devices (e.g., user device 102) and/or at one or more remote servers (e.g., media content source 1102 and/or server 1104 of FIG. 11) and/or at any other suitable computing device(s). Gaming assistance system 100 may be configured to perform the functionalities (or one or more portions thereof) described herein. In some embodiments, gaming assistance system 100 may comprise or be incorporated as part of any suitable application or software. For example, gaming assistance system 100 may comprise or be implemented in conjunction with one or more video games (and/or other extended reality (XR) media assets or XR experiences) to enhance performance and user experience and/or may comprise or employ any suitable number of displays, sensors or devices such as those described in FIGS. 1-12, or any other suitable software and/or hardware components, or any combination thereof. In some embodiments, an entity that releases or creates a video game may implement gaming assistance system 100.

User device 102 may correspond to or comprise, for example, may be, for example, a headset; a mobile device such as, for example, a smartphone or tablet; a video game console or any other suitable video game platform; a laptop computer; a personal computer; a desktop computer; a smart television; a smart watch or wearable device; smart glasses; an XR head-mounted display (HMD); a stereoscopic display; a wearable camera; XR glasses; XR goggles; a near-eye display device; or any other suitable user equipment or device capable of connecting to the Internet or other suitable network; or any combination thereof. Game engine 104 may be, for example, a software framework including relevant libraries and support programs for running, rendering, and executing a video game, e.g., video game 101 being played at user device 102 by user 111. Video game 101 is shown in FIG. 1 as a chess video game, although it should be appreciated that video game 101 may be any suitable single player or multi-player video game, e.g., a role-playing game (RPG), an action video game, a first-person shooter (FPS) video game, a sports video game, or any other suitable type of video game, or any suitable combination thereof.

As shown in FIG. 1, user device 102 executes gameplay of video game 101, e.g., based at least in part on inputs received from a primary player, user 111, that is an active player of the videogame during gameplay. User device 102 may provide video game 101 to user 111 based on a locally or remotely stored copy of video game 101, based on physical medium at a game console, based on accessing an application or website providing video game 101, and/or based on receiving video game 101 from, e.g., a server or other device over a network or other communication link. In some embodiments, user device 102 may capture gameplay data and interact with other components of gaming assistance system 100 and one or more AI models, and user device 102 displaying output of the gaming assistance system 100 to user 111.

In some embodiments, game engine 104 (e.g., executing at a remote server and/or locally) monitors the gameplay performance of video game 101 being played by user 111. For example, game engine 104 may be implemented at a remote server that is in communication with user device 102. Monitoring may be based on techniques such as, for example, computer vision and/or video game statistics analysis, and/or any other suitable technique, for a current session and/or previous session of video game 101, to identify data indicative that user 111 is experiencing difficulty progressing in video game 101. For example, game engine 104 may detect, using computer vision, that gameplay has not progressed beyond a first scene within a given time frame. In another example, game engine 104 may detect that a gaming session, e.g., at a certain level, has earned points below a given threshold, or has been stuck on a certain level, event, or move for at or above a threshold amount of time. In another example, game engine 104 may detect that a character or profile being controlled by user 111 has repeatedly (e.g., at or above a threshold number of times, in a current video game session and/or across multiple historical video game sessions) failed to advance past (or replayed) a current (or upcoming) level, opponent, event, challenge, or other portion of video game 101. As another example, inputs of the user, e.g., detected audio indicating frustration with a portion of video game 101 during broadcast of the game, or electronic communications (e.g., phone calls, text messages, forum posts, or social media posts) expressing frustration with a portion of video game 101, may be considered by game engine 104 as part of the monitoring.

At timepoint 150, the game engine 104, based at least in part on the monitored video game data, detects a challenge in gameplay of video game 101 by user 111. For example, game engine 104 may determine that, for a current arrangement of pieces on the chess board in video game 101, a win probability for user 111 is at or below a threshold level (e.g., 20%). As another example, game engine 104 may determine that a current arrangement of pieces on the chess board in video game 101 is similar to or is the same as previous arrangements in chess matches played by user 111 in which user 111 lost the chess match at least a threshold percentage of the time (e.g., 60%). As another example, game engine 104 may determine that user 111 has never beat the particular opponent before, or historically has lost to this opponent at least a threshold percentage of the time. As yet another example, a user interface input from user 111 may be detected in which user 111 requests assistance in video game 101.

Based at least in part on detecting the challenge at timepoint 150, game engine 104 may access a repository 106 of AI models 103, 105, 107, and 109 for providing gameplay assistance or guidance to user 111 at the current portion (or an upcoming portion) of video game 101. In some embodiments, the AI models 103, 105, 107, and 109 are trained based at least in part on gameplay data of respective skilled players 1, 2, 3, and 4, of the same video game 101, or similar video games (e.g., depending on the type of game, for example, other chess video games than video game 101 may retain many if not all of the same strategic considerations of video game 101). Such skilled players may be determined to have skill level above a certain threshold with respect to the video game 101 and/or similar video games. For example, a skilled player may receive an invitation to train an AI model based on the skilled player's gameplay statistics (e.g., how efficiently the skilled player completes challenges or wins a level or match or portions thereof), based on the skilled player reaching a threshold score or rating (e.g., user ranking on a leaderboard) in video game 101 (or a similar video game), based upon the skilled player's achievements or reputation amongst peer video game players, and/or based on any other suitable data. Alternatively, an AI model may be automatically trained based at least in part on such a skilled player's gameplay, e.g., based on the skilled player opting into a privacy policy for video game 101 when initially playing the video game. While four models are shown for simplicity in repository 106, it should be appreciated that any suitable number of AI models for providing gameplay assistance may be stored for multiple different video games or portions thereof. In some embodiments, a difficulty level (e.g., easy or hard) of video game 101 selected by user 111 may influence which AI model is recommended to the user. For example, an AI model where a skilled player is playing at the same difficulty level may be recommended.

To obtain the training data for each AI model of a skilled player, the gaming assistance system 100 may capture gameplay data of the skilled player to train an AI model that reflects inputs received, and decisions of, the skilled player (and any other suitable data, such as, for example, equipment or weapons used by the skilled player) at various portions of video game 101. In one example, a skilled player may enable their gaming console or cloud gaming platform to capture, via the connected gaming assistance system 100, their gameplay. In embodiments involving AI models of a group, the gaming assistance system 100 may capture gameplay of a skilled group or team. The gaming assistance system 100 may then create an AI model based on the captured gameplay, to be stored at repository 106, and which may be shared with user device 102 of user 111. In some embodiments, the AI model acts as an in-game assistant for user 111, which may, for example, help user 111 beat a difficult opponent or level, make an advantageous next move(s) (e.g., in the chess match of video game 101) or reach another in-game goal. Skilled gamers may monetize their gaming data by lending or allowing other players to be guided based on their gaming behavior.

In some embodiments, the gaming assistance system 100 assigns to the AI models scores and rankings, and the game engine 104 (or user 111) may, at timepoint 160, select an AI model for importation into the gaming session of user 111 for video game 101 based at least in part on the score or ranking. The scores and ranking may be, for example, values that are based on a similarity of the AI model of the skilled player to user preferences of user 111 (e.g., if user 111 likes to play with a certain weapon, or likes a certain chess strategy, similar to the skilled player of a particular AI model), and/or a success rate of other users in completing a challenge or other video game event when playing video game 101 with guidance from a particular AI model 103, 105, 107, or 109. For example, users having had a particular AI model imported into their gaming session may rate an AI model, and/or gameplay statistics from such gaming sessions may be analyzed. In another example, a rating might be based on the number of followers of a skilled player (e.g., on Twitch) or of an AI model, or a number of gaming sessions the AI model (or AI models of the skilled player generally) has been imported into. The scores and rankings may also be related to the source, for example, the skilled player of the AI model, or any other suitable metric. In the example of FIG. 1, game engine 104 has analyzed the scores and rankings of the AI models and as a result, selects skilled player 3 model 107 for recommendation to be imported into the gaming session of user 111 for video game 101, from the collection of four available models in repository 106.

In some embodiments, the gaming assistance system 100 may, based at least in part on selecting one or more AI models for recommendation, automatically import such AI model 107 into the current gameplay session of user 111 for video game 101, or may present the AI model(s) on the user device 102 for recommendation and approval, as shown by option or selection box 110. For instance, in FIG. 1, selection box 110 displays on user device 102 a message recommending the AI model skilled player 3 model. Selection box 110 asks user 111, via user device 102, if he or she would like to import the skilled player 3 model. User device 102 then may receive input 112 indicating a selection to import the skilled player 3 model, and an indication of such input may be received by gaming assistance system 100. In some embodiments, an interface of user device 102 may present a ranked list of skilled player models, e.g., each of model 103, 105, 107, and 109, with model 107 having a highest ranking on the list.

The gaming assistance system 100 may then, in some embodiments, based at least in part on the determination to automatically import such AI model or based at least in part on the received input, import the selected model, here the skilled player 3 model 107, into the current gaming session of user 111 for video game 101. The AI model may be provided access to the current gaming session data, such as, for example, timepoint, location, player level, elapsed time for a current level or move, elapsed time for the current gaming session, points earned, and/or other data relevant to gameplay of user 111 for video game 101. The AI model or game engine may analyze the available data to determine a current state of the game, e.g., location, time, progress within the game, and/or any other suitable data.

At timepoint 170, the game engine 104 uses the AI model to recommend, based at least in part on the current game state of user 111 for video game 101, an action in the gaming session from a list of possible actions 114. The AI model may use gaming session data (e.g., current arrangement of chess pieces on the chess board, in the example of FIG. 1) to determine an action or actions most likely to increase or improve gameplay performance, likely to result in the highest number of points or rewards, or based on any other suitable metric, for the current portion of the video game 101, and may output an indication of that action or actions to the game engine 104. The AI model may select an action that the skilled player on which the model is based would have most likely chosen. The predicted actions of a skilled player may be based on moves, strategies, or other considerations of the skilled player, for example, as gleaned from that skilled player's historical gameplay data.

In some embodiments, the AI model may rank possible actions to determine action(s) for recommendation. In such an example, the AI model may, for instance, determine all or multiple possible options (e.g., 113, 115, 117, and/or 119) at a given current game state, and may then rank the possible actions based on relevant factors. The relevant factors for ranking may be any factors relevant to game performance and may include metrics such as, for example, a skilled player's preference, user 111's style or preference, an opponent's likely response, gameplay time required for success after the action, and/or the points or levels likely to be earned, and/or any other suitable data. In the example shown in FIG. 1, the AI model selects Move 4 (e.g., move knight to c5), indicated at 119, as a recommended action.

In some embodiments, each of the ranked options may be provided at user device 102 for display, or only a top ranked recommendation may be displayed. For example, gaming assistance system 100 may initiate a display 116 at user device 102 suggesting the recommended action. The display 116 (and/or option 110) may be, for example, an overlay that is displayed over the gameplay of video game 101, or during a break in gameplay, or on a second screen device of the user 111, to avoid disrupting gameplay. The display 116 may take any form capable of conveying the recommended action. For example, as seen in FIG. 1, the display 116 is text indicating “Player 3 would use Move 4,” and may specify which move in a textual and/or visual manner: in anaudio output, in an image; video or animation showing a demonstration of such move; and/or in any other suitable manner. For example, the gaming assistance system 100 may guide user 111 by displaying instructions in text form or rendering audio and/or video instructions. In some embodiments, the gaming assistance system 100 uses a generative AI model to create the gameplay assistance, at least in part. For example, if the data that trained the AI model includes the voice of a skilled player, then voice of that skilled player may also be included in the generated video output by the generative AI model.

Based at least in part on the suggestions, gaming assistance system 100 may give instructions to improve gameplay. That is, the series of suggested actions may provide step-by-step instructions, or actions, to defeat a boss in a boss fight, complete an adventure, finish at a certain level, or perform any other suitable video game task, e.g., based on how the skilled player would have handled the particular gameplay portion that user 111 is currently (or is about to be) playing. In embodiments in which the AI model is based on a skilled player's decisions, the AI model may, having analyzed the gameplay of the skilled player, predict the decisions of the skilled player in a given scenario or game state. Knowing the decisions of the skilled player, the AI model may provide specific instructions or hints, through the recommended actions, to another player (e.g., user 111) to encourage the other player to emulate the gameplay of the skilled player. In some embodiments, the AI model may prepare the instructions in advance to avoid delay.

User 111 may choose to follow the instruction and perform the recommended action or may ignore the suggestion and choose another option, or provide gameplay inputs unrelated to the recommend action. In some embodiments, game engine 104 continues to monitor gameplay after causing display of the recommendation, and potentially recommends additional actions, at the same portion of video game 101 shown in FIG. 1 or at subsequent portions of video game 101, based at least in part on the monitored gameplay. In this way, the gaming assistance system 100 may provide personalized assistance, improving satisfaction and performance, throughout the gameplay session at any suitable time.

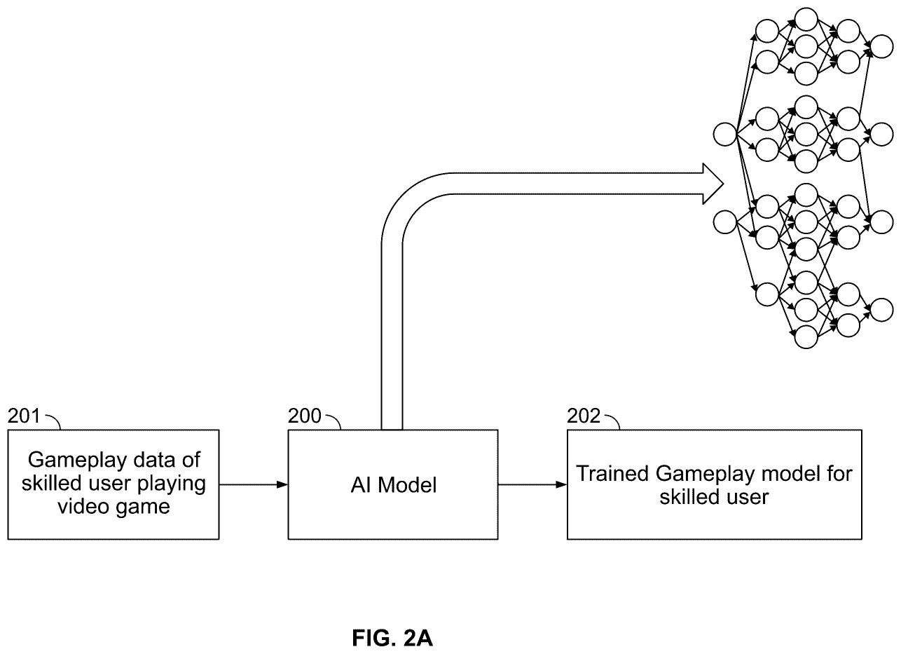

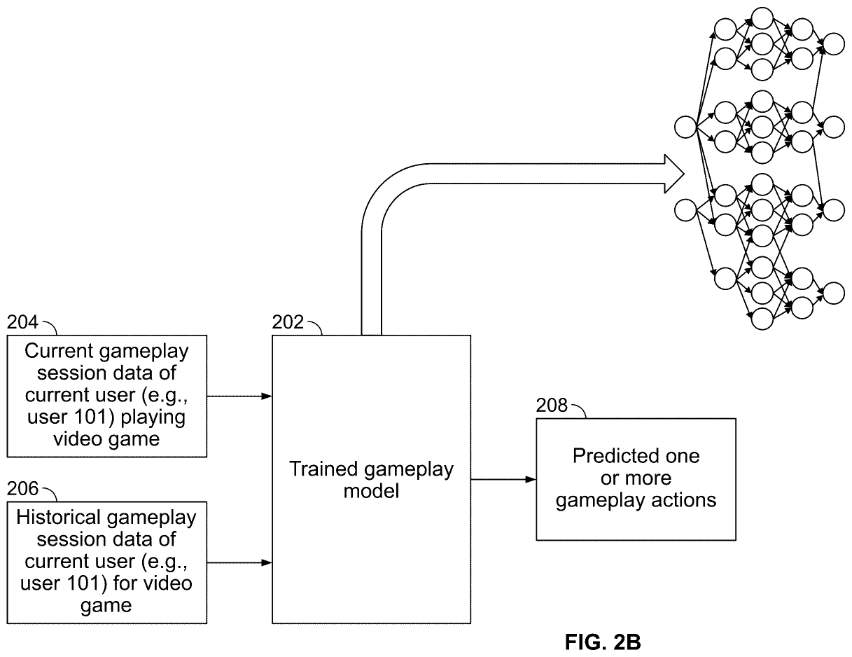

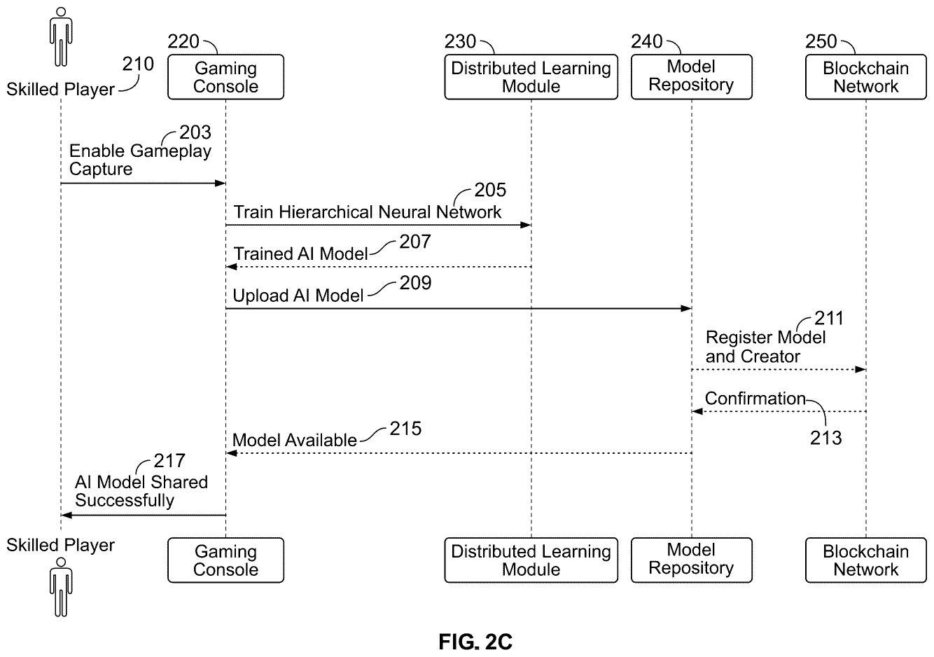

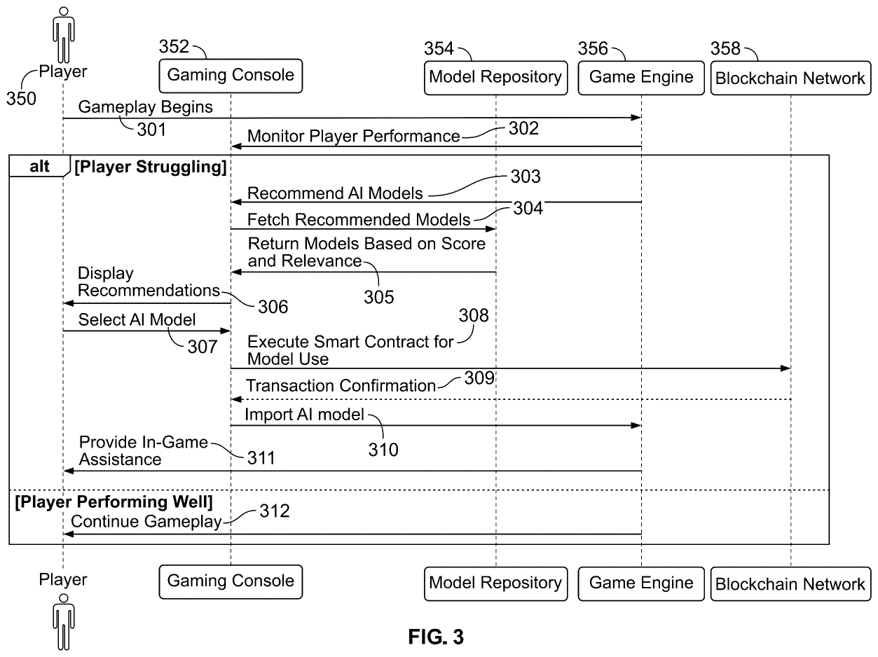

FIG. 2A shows an illustrative AI model 200, in accordance with some embodiments of this disclosure. In some embodiments, AI model 200 may be a machine learning model such as, for example, a neural network, e.g., a recurrent neural network, a transformer, a classifier, or any other suitable type of AI model, or any combination thereof. In some embodiments, AI model 200 may be trained to obtain gameplay model 202. Gameplay model 202 may correspond to one or more skilled players (e.g., skilled player 3 indicated at 107), and to obtain gameplay model 202, AI model 200 may be trained using any suitable amount of training data, e.g., comprising gameplay data 201 of such skilled user playing a particular video game (e.g., video game 101 of FIG. 1) and/or other video games similar to the particular video game. For example, the gameplay data 201 of the skilled user may comprise video of the skilled user playing the video game, audio spoken by the skilled user during gameplay of the video game, text entered by the skilled user during gameplay of the video game, inputs received from the skilled user during gameplay, statistics or attributes derived from the skilled user's gameplay (e.g., weapons or equipment or items used by a video game character controlled by the skilled user, a route on a map taken by the character, a certain character used by the skilled player for a certain level, amount of time to complete a challenge, etc.), and/or any other suitable data. In some embodiments, portions of the gameplay data used to train AI model 200 may correspond to successful completions of challenges or tasks in the video game.

In some embodiments, AI model 200 may be trained by an iterative process of adjusting weights (and/or other parameters) for one or more layers of AI model 200. For example, the gaming assistance system 100 may compare the outputs obtained when training data is input to model 300 to a ground truth value (e.g., an annotated indication of the correct output). The video capture application may then adjust weights or other parameters of machine learning model 200 based on how closely the output corresponds to the ground truth value. The training process may be repeated until results stop improving or until a certain performance level is achieved (e.g., until 95% accuracy is achieved, or any other suitable accuracy level or other metrics are achieved). In some embodiments, model 200 may be trained to learn features and patterns with respect to particular features of input images and gaze angle sequences, and such learned patterns and inferences may be applied to received data once model 200 is trained. In some embodiments, model 200 may be trained, may continue to be trained on the fly or may be adjusted on the fly for continuous improvement, based on input data and inferences or patterns drawn from the input data, and/or based on comparisons after a particular number of cycles. In some embodiments, model 200 may comprise any suitable number of parameters.

In some embodiments, model 200 may be trained with any suitable amount of training data from any suitable number and/or types of sources. In some embodiments, machine learning model 200 may be trained by way of unsupervised learning, e.g., to recognize and learn patterns based on unlabeled data. In some embodiments, machine learning model 200 may be trained by supervised training with labeled training examples to help the model converge to an acceptable error range, e.g., to refine parameters, such as weights and/or bias values and/or other internal model logic, to minimize a loss function.

In some embodiments, each layer may comprise one or more nodes that may be associated with learned parameters (e.g., weights and/or biases), and/or connections between nodes may represent parameters learned during training (e.g., using backpropagation techniques, and/or any other suitable technique). In some embodiments, the nature of the connections may enable or inhibit certain nodes of the network. In some embodiments, the gaming assistance system 100 may be configured to receive (e.g., prior to training) user specification of (or automatic selection of) hyperparameters (e.g., a number of layers and/or nodes or neurons in each model). The gaming assistance system 100 may automatically set or receive manual selection of a learning rate, e.g., indicating how quickly parameters should be adjusted. In some embodiments, the training image data may be suitably formatted and/or labeled by human annotators or otherwise labeled via a computer-implemented process. As an example, such labels may be categorized as metadata attributes stored in conjunction with or appended to the training image data. Any suitable network training patch size and batch size may be employed for training model 200. In some embodiments, model 200 may be trained at least in part using a feedback loop, e.g., to help learn user preferences over time. In some embodiments, the gaming assistance system 100 may perform any suitable pre-processing steps with respect to training data, and/or data to be input to the trained machine learning model. Machine learning model 200, gameplay data 201, and gameplay model 202 may be stored at (and/or implemented at) any suitable device(s) and/or server(s) associated with the gaming assistance system 100.

As shown in FIG. 2B, trained gameplay model 202 may be used to provide gameplay assistance to a user, e.g., user 111 of FIG. 1, that is determined as likely to be in need of gameplay assistance for a video game. For example, trained gameplay model 202 may receive as input current gameplay session data 204 of user 111 (e.g., an arrangement of pieces on the chess board). This may allow for game state synchronization between the user 111's gaming session and the gameplay model, e.g., determining what part of a level that user 111 is currently playing or is about to play. In some embodiments, trained gameplay model 202 may receive as input historical gameplay session data 206 of the current user (e.g., indicating a user's preferences for certain strategies, characters, items, etc.). Based on these inputs, trained gameplay model 202 may output one or more predicted gameplay actions 208. For example, gameplay model 202 may learn through the training process tendencies, strategies and inputs received from the skilled player associated with trained gameplay model 202, gameplay model 202 may output predicted gameplay action(s) 208 based on actions performed by the skilled user at a same portion of video game that the user 111 is currently at, or at a similar portion. In some embodiments, the one or more predicted gameplay actions 208 may not correspond to, e.g., actual actions taken by the skilled player in the same situation, but rather gameplay model 202 may infer what the skilled player likely would have done if in the same situation that user 111 is currently in. In some embodiments, gameplay model 202 may comprise or be in communication with a generative AI model, which may be configured to generate images, audio, video and/or other data associated with gameplay of the skilled user, e.g., personalized audio guidance in the voice of the skilled user, actual video footage of the skilled player playing or artificially generated footage, based on the tendencies of the skilled user, of how the skilled user would approach user 111's current situation.

The described gaming assistance system 100 for implementing AI gaming assistance may, in some embodiments, comprise hierarchical neural networks, distributed learning frameworks, and game engine integrations, each described in detail below. Some embodiments may also implement model exchanges mechanisms and distributed ledgers (e.g., blockchains).

In some embodiments, AI model 200 and gameplay model 202 may be hierarchical neural networks, e.g., AI models of game play or gameplay instructions that are trained on a skilled player's gameplay data and act as in-game assistants for other players. For example, the AI model 107 for skilled player 3 in relation to FIG. 1 may be a hierarchical neural network.

Hierarchical neural networks may be designed to capture complex gaming behaviors at multiple levels. For example, at a low level, hierarchical neural networks might capture actions such as basic controls and movements. At a mid level, they may capture strategies, including tactical decisions and patterns. At a high level, they may capture more complex strategies such as overall game plans and adaptive strategies. In some embodiments, AI model 200 and gameplay model 202 may employ distributed learning. Distributed learning frameworks enable training of AI models across multiple user devices without centralizing sensitive gameplay data. For example, they may allow AI models to train locally on players' devices, preserving privacy. The frameworks may share and aggregate periodic updates (e.g., model weights) to improve the global model without transferring raw gameplay data.

In some embodiments, gaming assistance system 100 may employ model exchange mechanisms to facilitate sharing, recommending, and/or monetizing AI models between players. Using these mechanisms, skilled players can create AI models by enabling their devices to capture their gameplay and train AI models using the collected data. The mechanisms may also allow skilled players to specify availability of an AI model. For example, a skilled player may choose specific games, levels, or characters for which the AI model is applicable. The skilled players may also set permissions and define whether an AI model can be modified, fine-tuned, or redistributed. In some embodiments, skilled players can also monetize models-that is, they may share models with other players for a fee or reward, with customizable revenue sharing options. In some embodiments, the gaming assistance system 100 incentivizes other players to improve models, for example, through points or payment, fostering a collaborative environment.

Model exchange mechanisms may also allow interactions with primary players, such as user 111 discussed in relation to FIG. 1. For example, primary players may discover useful AI models, such as finding AI models based on game, level, character, or following preferred skilled players to receive model updates or other information. Primary players may also import AI models and use the imported AI models for assistance during gameplay sessions, levels, or critical events. In some embodiments, with permission, primary players may fine-tune or retrain imported models to suit their playstyle. In some embodiments, primary players are prompted to agree to the terms of use and permissions when importing or modifying models. In some embodiments, primary players may monetize enhanced models, if allowed. For example, primary players may fine-tune existing models and share their fine-tuned models, sharing revenue according to the original creator's (e.g., the skilled player) permissions. In some embodiments primary players may rate models and/or provide feedback, influencing model scores and recommendations.

In some embodiments, gaming assistance system 100 employs distributed ledgers (e.g., blockchain) to ensure secure, transparent transactions on a blockchain and enforce usage polices through intelligent contracts. For example, blockchain technology can provide secure transactions using intelligent contracts for payments, usage enforcement, and permission management. Blockchain can also keep immutable records of model exchanges, transactions, modifications, and revenue sharing and distribution for greater transparency and security. These platforms may also ensure that models are used, modified and distributed according to the original creator's terms, and that all parties are fairly compensated. These features can garner trust among users. In some embodiments, the blockchain includes all permissions, terms, and revenue-sharing arrangements and stores them transparently. In some embodiments, the gaming assistance system 100 uses blockchain technology to enforce permissions of AI models, such as restrictions on modification or redistribution. The blockchain may also record transactions to ensure security. In some embodiments, if a player attempts to redistribute an AI model without the original creator's permission, the gaming assistance system 100 may prevent this action, ensuring that players use AI models only as authorized.

In some embodiments, gaming assistance system 100 may import real time or near real time assistance during gameplay based at least in part on integrating a game engine with, or interfacing the game engine with, AI models. This interface may be responsible for collecting game data, sending it to the AI model, and then applying AI-driven insights back into the game. The game engine may interface with AI models to detect when a primary player is having difficulty. There are many ways to connect an AI model with the game engine. For example, the two componentss may be directly integrated using, for example, an API where a specific game has an official API to allow external models to read the game state data. The game engine may also recommend AI models. For example, it may suggest AI models to assist a primary player, including fine-tuned versions. It may also provide guidance in the form of displaying instruction and audio cues or generating video instructions using generative AI and enforcing usage policies by ensuring AI models are used, modified, and distributed only as authorized. The game engine integrations may use various methods to monitor gameplay, such as computer vision that analyzes the game screen. It may further access game data by accessing a memory state of a game. Alternatively, or in addition, a plug-in may provide access to game data.

In some embodiments, the gaming assistance system 100 may limit use of any particular AI model. For example, the gaming assistance system 100 may receive input from a device or account associated with a skilled player to enable the assistance feature for specific games, levels of a game, and/or specific character(s), in some embodiments. This feature may be available through an options category or other method. For example, a game engine connected to the gaming assistance system 100 may only allow players with certain scores to choose to create an AI model to discourage the creation of ineffective models. In some embodiments, the feature may be automatic for certain levels. The ability to share the AI model may be optional.

As many AI models become available for different games, levels, or characters, the gaming assistance system 100 may score each model and recommend the models to a primary player who needs help. The gaming assistance system 100 may, for example, recommend an AI model to all players, players demonstrating low skill level, or to players who have opted in to this feature. Primary players may follow other players via the AI model. In some embodiments, the AI model may be used only for one gaming session, a particular level, or a key event at a level (e.g., boss fight). In some embodiments, primary players or platforms may provide visibility regarding who has used a particular model. For example, a player may opt into a setting that displays which AI models the player has used or is using. In another example, a platform may include an aspect in which it lists players who have used or are currently using each model. The player may select a default model for a particular game or pre-select a model before starting the gaming session. This allows importing the model without further user input while playing the game.

The gaming assistance system 100 may score the AI models for distinct circumstances such as for each game, level, or character. Gaming assistance system 100 may then import, via a game engine interface, the AI model or models into a particular gaming session of a primary player as needed for guidance (for example, the gaming assistance system 100 may import an AI model for just one session, level, or key event). For example, in response to determining that a primary player is struggling during gameplay, the gaming assistance system 100 may recommend an AI model that can help guide the primary player. The gaming assistance system 100 may detect that a primary player is struggling based on several factors, including, for example, points earned, or time elapsed. It should be noted that this feature may not be available in cases of poor connectivity between client and server (e.g., playing the game while connecting to a cellular connection). In some embodiments, the gaming assistance system 100 provides the assistance only during critical portions of the game in such a circumstance.

The gaming assistance system 100 may allow real time or near real time gameplay to rely, at least partially, on AI models without introducing significant delays that impact the user experience. For example, in one embodiment, the AI model predicts gameplay that has yet to occur and prepares corresponding instruction(s) ahead of time. These predictions may help provide guidance without significant delays and improve user experience.

In some embodiments, the gaming assistance system 100 may import or activate individual AI models for multiple players in a multi-player game (e.g., to adopt gameplay style of various gamers that they prefer). In such embodiments, the gaming assistance system 100 tracks each player's (of the multiple players in the multi-player gaming session) gaming actions and utilizes the corresponding AI model based on collected playing data. In some embodiments, each player may import different AI models reflecting their preferred gameplay styles. In some embodiments, different portions of the AI model may be mapped to roles of different players of the multi-player game.

In some embodiments, the gaming assistance system 100 may suggest the AI model of a group of skilled players to a group of primary players. For example, the gaming assistance system 100 may recommend that a group of players in a multi-player gaming session import a model trained on multi-player gaming sessions of a winning team of players. In some embodiments designed for team environments, the AI model provides synchronized assistance to all team members, enhancing coordination and teamwork. The gaming assistance system 100 may integrate this assistance with in-game communication systems, providing real time or near real time strategic advice without disrupting player interaction and without interrupting gameplay.

Furthermore, in some embodiments, players who import AI models can fine-tune or retrain an AI model using gameplay data to suit a specific playstyle. In some embodiments, players may only fine-tune an AI model with the originating skilled player's permission. The gaming assistance system 100 may, in some embodiments, receive permissions regarding whether others can modify or redistribute an AI model. If redistribution is allowed, the gaming assistance system 100 can share modified AI models with other players, whether primary or skilled players. In some embodiments, the gaming assistance system 100 may, according to predefined terms, share revenue from the redistributed AI model between both the originating skilled player on whose data the AI model was trained and the modifier.

Additionally, in some embodiments, the gaming assistance system 100 manages ownership and rights when AI models are modified and redistributed, ensuring that creators receive proper attribution. Modified AI models may include metadata referencing the original AI model and creator, and maintaining a clear lineage of contributions. This metadata may establish a record that prevents a player from generating and monetizing new models that are trained based on the gaming data collected from someone else's gameplay. In other words, the gaming assistance system 100 provides effective guardrails on distinguishing pure gameplay vs. model-assisted gameplay when annotating and collecting data for training and improving AI models. When the gaming assistance system 100 identifies assistance at a minimal level, e.g., identifies that a player is at a similar level of gameplay as a selected AI model, the gaming data of that player may also become valid training data. A modified AI model may include or be associated with metadata referencing the original model and creator.

In some embodiments, an AI model can present a time-scaled guidance path with visual cues. In some embodiments, a primary player can subscribe to a skilled player's AI model as a long-term guide across multiple sessions. The gaming assistance system 100 may incentivize players to improve and enhance AI models by providing revenue-sharing opportunities and recognition within the community. For example, skilled players contributing high-performing models or significant enhancements can gain recognition to motivate participation.

In some embodiments, a skill trajectory mode allows primary players to follow a time-scaled guidance path that highlights key strategies the skilled player model uses within a level. This feature offers a “learn by doing” experience, where primary players can replay a level or session with real time or near real time visual cues, such as markers, paths, or dynamic prompts, that illustrate what the skilled player would have done at specific stages. As players progress through the level or session, the gaming assistance system 100 may, in some embodiments, progressively unlock more advanced techniques, customized based on observed improvement. This replay mode may also, in some embodiments, enable primary players to pause at specific segments to review additional guidance, repeat sections until they achieve proficiency, or advance once the technique is mastered, thus providing a structured and adaptive learning experience.

In some embodiments an AI mentor feature enables primary players to adopt an AI model of a skilled player as a long-term guide across multiple levels or game sessions. This AI mentor adapts over time, offering continuous support aligned with the skill progression of the primary player. As the primary player improves, the AI mentor may shift its focus from providing basic tactical advice to offering more advanced strategic guidance, simulating a growth-oriented learning environment. The AI mentor may also, in some embodiments, set short-term objectives for the primary player, provide encouragement, and adapt guidance based on recurring challenges the player encounters.

In some embodiments, a leaderboard and social sharing system for AI models may enable players to discover, rate, and share AI models based on the effectiveness of the models (an effectiveness score) and popularity. In some embodiments, the gaming assistance system 100 calculates this effectiveness score using data on each primary player's success rate before and after using the AI assistant model, providing an objective measure of how much the model improved performance. For instance, if a primary player consistently failed a specific level before using the model and succeeded afterward, this improvement would positively impact the model's effectiveness score.

In some embodiments, gaming assistance system 100 incorporates the AI model training process into the gaming assistance system 100. That AI training process may include data collection in which the gaming assistance system 100 collects gameplay data, particularly that of a skilled player, with the player's consent. The process may also include local training in which the gaming assistance system 100 trains models using data on the player's device. The process may further include privacy preservation in which the game engine prevents raw gameplay data from being shared and ensures that only model updates are communicated. In some embodiments the gaming assistance system 100 anonymizes data and/or uses secure distributed platforms to protect privacy. In some embodiments, the importing player uses gameplay data to fine-tune the model on their device.

The AI model may perform inference and assist the player during gameplay. In some embodiments, the gaming assistance system 100 first integrates the AI model into gameplay. In some embodiments, the gaming assistance system 100 loads the AI model into an assistance system upon import. The AI model may access the current gameplay state, including, for example, player position, inventory, mission progress, and environmental factors. The AI model may then process the current game state using hierarchical neural networks to understand the situation at various levels (tactical, strategic, and overall objectives). Based on the analysis, the AI model may predict possible difficulties or threats the player may encounter shortly after.

The AI model may formulate action recommendations that align with the skilled player's style and are optimized for the current situation. A game interface may then convey the recommendations through pop-up hints, visual cues, audio messages, or video instructions. The AI model may update its analysis based on the player's actions, ensuring more relevant advice in the future. The AI model may also learn from new data collected during gameplay if permissions allow it.

FIG. 2C illustrates a workflow of AI model creation and sharing, in accordance with some embodiments of this disclosure. At step 203, a skilled player 210 enables gameplay capture on his or her gaming console 220, such as user device 102, through, for example, selecting an option to capture gameplay or an automatic feature of a specific game or account. In some embodiments, such gameplay capture may be automatic (e.g., for a user that is streaming their gaming session on Twitch, or otherwise). In some embodiments, the gaming assistance system 100 may only capture specific game plays, such as, for example, important boss fights, rather than capture all gameplay. The gaming assistance system 100 may trigger the capture of the event in the gameplay (e.g., boss fight is about to start) in some embodiments. The amount of gameplay captured may be an optional setting, a specific software feature, or triggered through another mechanism. The gaming console 220 then collects the gameplay data as captured and sends the data (e.g., over a communication link) to a distributed learning module 230. At 205, the distributed learning module 230 receives the gameplay data from the gaming console 220, and, using this data, trains a hierarchical neural network to create an AI model that incorporates gameplay data of the skilled player 210. The distributed learning module 230 returns the created AI model to the gaming console 220 for future use at step 207. The AI model, in some embodiments, mimics or predicts the actions of the skilled player 210 during gameplay such that other players may see how skilled player 210 plays a game or makes decisions.

At step 209, the gaming console 220 has updated the created AI model, for example by fine-tuning performance, adding additional data, or customizing the model to a specific player, and sends the updated AI model to a model repository 240 for registration. At step 211, the model repository 240 registers the model and creator of the updated AI model on blockchain network 250, a centralized network for maintaining records related to AI models. The blockchain network 250, at step 213, sends confirmation of receipt and recordation of the records related to the updated AI model to the model repository 240.

At step 215, the model repository 240 alerts the gaming console 220 that the updated AI model is available following proper recordation on the blockchain network 250. The gaming console may then, at step 217, alert the skilled player 210 that the gaming console 220 successfully shared the AI model based on the gameplay capture.

FIG. 3 illustrates an example workflow in which the gaming assistance system 100 recommends and imports an AI model to a current gaming session, in accordance with some embodiments of this disclosure. First, at step 301, a player 350, such as a primary player, begins gameplay, that is playing a game, thereby interacting with game engine 356. At step 302, the game engine 356 monitors player performance (e.g., the performance of player 350) at gaming console 352. Monitoring may include collecting metrics such as time elapsed during gameplay, points earned, or level reached. In some embodiments, the game engine may determine, based on the monitoring, that a player is having difficulty or underperforming. The game engine 356 may then, at step 303, recommend AI models that can provide guidance to the player 350 via gaming console 352. The game engine may base its recommendation on data such as model ratings, user preferences or model permissions.

Gaming console 352 then, at step 304, fetches the recommended models from the model repository 354, which stores the models and is connected to the game console via, for example, Wi-Fi or a wired connection. At step 305, the model repository responds to the request for AI models and returns models based on a score and relevance to the gaming console 352.

Gaming console 352 may then, at step 306, display recommendations to the player 350. For example, the game engine may display a message asking a player if they would like to import one of a list of AI models. In some embodiments, the game engine 356 may display a message asking if the player would like additional assistance.

The gaming console 352 then receives input from the player 350, at step 307 selecting an AI model. The selection may be, for example, a selection from a list or a selection of an option to import additional help. At step 308, the gaming console 352 executes a smart contract for model use using data from a blockchain network 358 used to record data regarding the AI models; that is, permissions are encoded on a blockchain, ensuring compliance. The gaming console 352 may also record the smart contract on the blockchain network 358. The blockchain network 358, at step 309, in response to receiving notice of the smart contract, sends a transaction confirmation to gaming console 352.

At step 310, the gaming console 352 imports the selected AI model to the game engine 356 for in-game use. The game engine 356 then at 311, provides in-game assistance to the player 350 as directed by the AI model. If the player 350 performs well, the game engine 356 continues gameplay uninterrupted, at step 312.

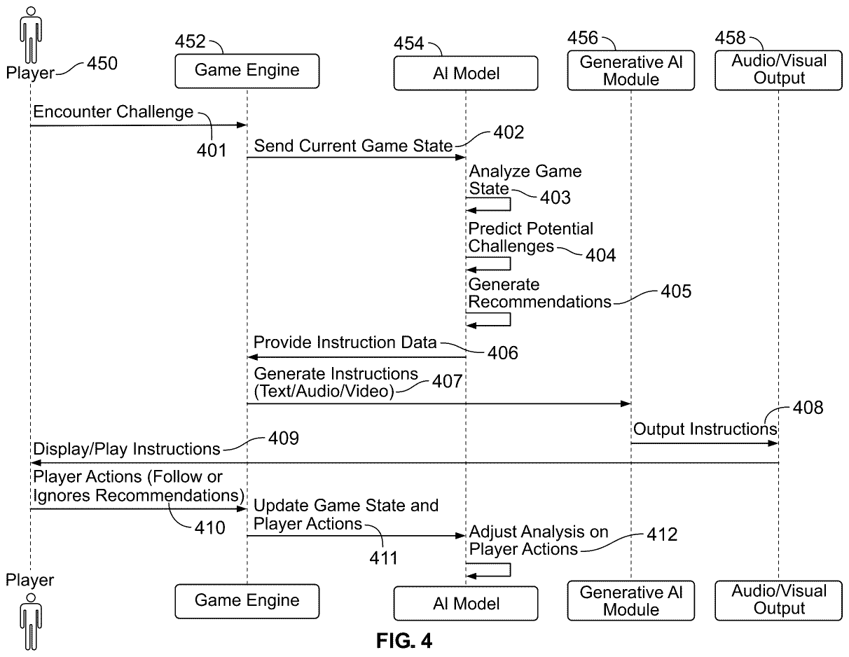

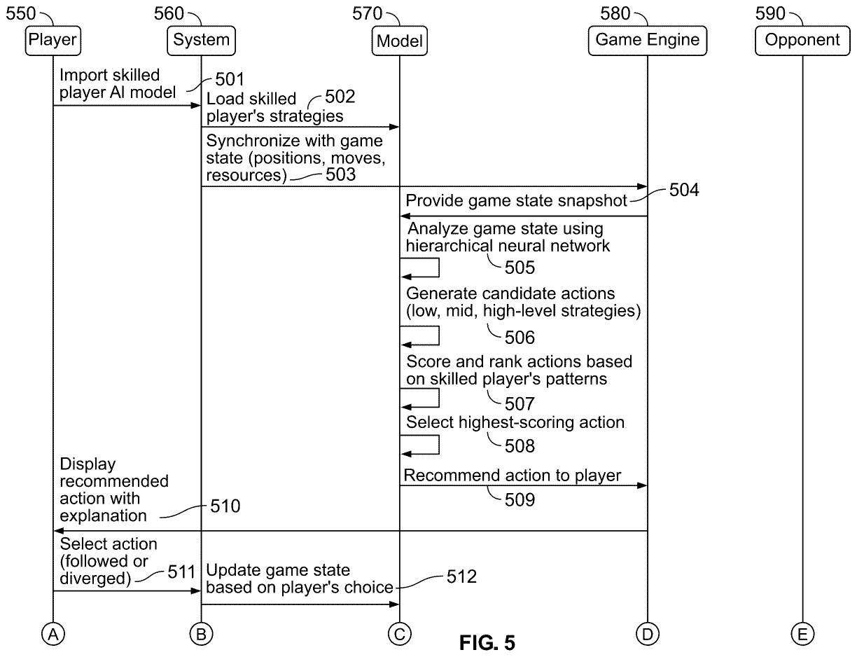

FIG. 4 illustrates an example workflow of in-game gameplay assistance using an AI model, such as the skilled player 3 model seen in FIG. 1. At step 401, player 450, such as a primary player, encounters a challenge. The game engine 452 detects that the player 450 is having difficulty using gaming metrics such as elapsed time or points earned. At step 402, the game engine 452, then sends the current game state to AI model 454. The current game state might include, for example, current level, player status, or any other relevant information. At step 403, AI model 454 analyzes the current game state, and at 404, based on the analyzed states, predicts potential challenges that player 450 is likely to encounter. These challenges may include reaching new opponents or terrains. At 405, the AI model 454 generates recommendations based on the current game state and taking into account the predicted potential challenges.

At step 406, the AI model 454 provides instruction data to the game engine 452. The instruction data represents suggested plays in the game, such as movements or strategies. The AI model 454 bases the instruction data on the data it has, that is, the current game state and its own training, and determines the instructions most likely to lead to in-game success. In-game success may be, for example, achieving a certain score, completing a level, or completing a task. The game engine 452, at 407, then generates instructions, such as text, audio, or video output, representing the instruction data for the generative AI module 456.

The generative AI model then, at step 408, generates and outputs the instructions it has received to an audio/visual output 458 in a form that a player 450 may understand, such as text or video instruction. At step 409, the audio/visual output 458 displays or plays the instructions for the player 450. In some embodiments, the audio/visual output 458 comprises instructions in a manner that does not interrupt gameplay.

The game engine 452 next receives input representing actions of the player 450 at step 410. The input may represent either following the provided instruction, that is performing the move or strategy suggested, or ignoring the provided instruction and instead performing another action. The game engine 452 then updates the game state and player actions at step 411 according to the input it received at step 410 and sends these updates to AI model 454. Finally, at step 412, the AI model 454 adjusts its analysis of the player's actions based on this update.

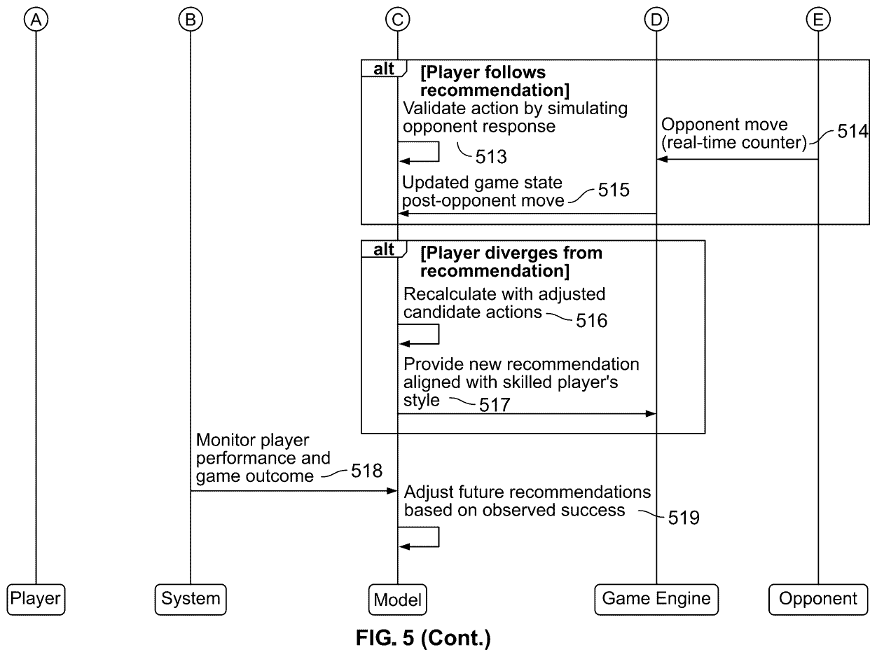

FIG. 5 illustrates an alternative embodiment of gameplay assistance using an AI model such as the skilled player 3 model seen in FIG. 1. At step 501, player 550, such as a primary player, imports a skilled player's AI model into their gameplay. At 502, the gaming system engine 560 loads the skilled player's strategies into the gameplay via the AI model 570. At step 503, the gaming system engine 560 synchronizes with the game state of the player 550, for example by synchronizing position, moves, a resource, using game engine 580. Game engine 580 in return, at step 504, provides a game state snapshot to the AI model 570. The game state snapshot may include data providing the current level of the game, player statistics, and other relevant information. For example, the game state snapshot may show that a player 550 is at level 4, with 50 points, and has reached the final opponent of the level. The AI model 570 then analyzes the game state using a hierarchical neural network at 505. This analysis may indicate skill level, preferences, or available options.

The AI model next, at step 506, generates a candidate action, such a low, mid, or high-level strategies. Candidate actions may be, for example, a specific move or tool selections. At step 507, the AI model 570 scores and ranks actions based on the skilled player's patterns. For example, the AI model 570 may rank an action the skilled player chooses most often above those reserved for more unique circumstances. At step 508, AI model 570 then selects the highest scoring action.

Once the AI model 570 selects an action, at step 509, it recommends the action to the player 550 via the game engine 580. The game engine 580 then displays the recommendation and an explanation to the player 550 at 510. The displayed recommendation may take any appropriate form, for example it may be a text notification or a shadow player. The player 550 may then, at 511, select an action, such following the recommendation or diverging to perform a separate action. At step 512, gaming system engine 560 may then update the game state based on the player's 550 choice. For example, the player 550 may choose to follow the recommendations or take alternative actions; the system collects feedback to monitor the player's actions to adapt subsequent recommendations; the AI model updates its analysis based on the player's actions, to help provide more relevant advice in the future; and the model may learn from new data collected during gameplay (e.g., if permissions allow).

In some scenarios, the player 550 follows the recommendation. In that case, at step 513 the AI model 570 validates the action by simulating an opponent 590 response. At 514, the opponent 590 may then move in response and, at 515, the game engine 580 may update the game state with the post-opponent move state.

In other scenarios, the player 550 diverges from the recommendation. In that scenario, the embodiment moves to step 516 in which the AI model 560 recalculates with the adjusted candidate actions. At 517, the AI model 570 then provides a new recommended action aligned with the skilled player's style of gameplay to the game engine 580.

Following the above steps, at step 518, the gaming engine system 560 continues to monitor the performance of player 550 and the game outcome. At step 519, the AI model 570 then adjusts future recommendations based on observed success.

For example, in the context of chess, the gaming assistance system 100 may train an AI model using data regarding Bobby Fisher's gameplay, that is, gameplay of a skilled player, to create a skilled player AI model. When the gaming assistance system 100 imports the “Bobby Fischer” AI model, the gaming assistance system 100 loads Fischer's playstyle, that is, his typical strategies, by way of the AI model. The gaming assistance system 100 may then use that AI model to guide a primary player through a match using a series of presented instructions or suggestions that are based on Fischer's playstyle.

When the AI model initializes, it synchronizes with the current game state, capturing the entire chessboard's configuration, including piece positions, player turns, and move history. In one embodiment, the gaming assistance system 100 processes this information into the form of model's input vector that represents the game state for analysis.

To provide move suggestions, the AI model may process the game state through a hierarchical neural network trained to recognize Fischer's unique strategies at various levels. The network's structure may enable it to analyze moves in layers, such as low-level tactics like avoiding a check or capturing a piece, midlevel strategies such as piece positioning for pressure, and high-level endgame goals Fischer often pursued. From this, the model may generate a list of candidate moves, ranked by their strategic advantage in the current gameplay and how closely they align with Fischer's playstyle. For example, in some embodiments, each potential move receives a score based on Fischer's historical decision patterns, prioritizing those that achieve control, pressure, or advantageous exchanges on the board. The gaming assistance system 100 then recommends the highest-scoring move to the player as the optimal choice.

In some embodiments, before finalizing the move recommendation, the AI model simulates potential responses from the opponent, for example in the example of chess, it may incorporate Grandmaster-level replies and Fischer's own defensive tactics. This validation step ensures that the suggested move not only aligns with Fischer's style but also anticipates strong counter moves. For example, if an opponent's hypothetical response would lead to significant material or positional loss, the AI model may select an alternative move from the list of ranked possible moves as a backup recommendation.

Once the AI model finalizes a move, the gaming assistance system 100 may recommend the move to the player via a display, for example through visual highlighting on the board or as text-based information. The recommendation may also, in some embodiments, include an explanation, such as detailing how this move reflects Fischer's typical tactics for the given scenario.

If the player chooses a move other than the recommendation, the AI model may recalibrate to accommodate the new board configuration, ensuring that it remains aligned with the ongoing game state. This adaptation allows the model to continue providing Fischer-like guidance as the game progresses, even if the player deviates from its suggestions.

Through continuous monitoring, the gaming assistance system 100 may also learn from the game's developments, allowing the model to further adjust its recommendations in response to observed outcomes, further personalizing or improving recommendations.

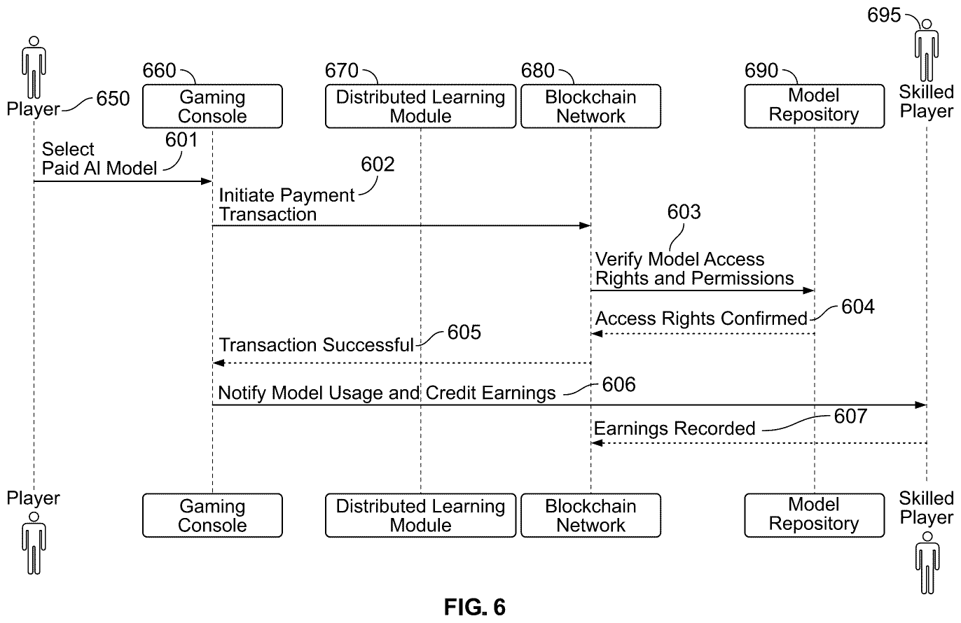

FIG. 6 shows an example embodiment of model monetization using blockchain technology. First, at step 601, a player 650 selects, for example through selecting an option or other user input, a paid AI model via a gaming console 660. The gaming console 660 then at step 602 initiates a payment transaction with a blockchain network 680 that houses model records. At step 603, the blockchain network 680 then analyzes its records and verifies AI model access rights and permissions using the model repository 690. At step 604, the model repository 690 returns a confirmation of access rights to the blockchain network 680. In response, at step 605, the blockchain network 680 informs the gaming console 660 that the transaction was successful. The gaming console 660 then, at step 606, notifies a skilled player 690 of AI model usage and credit earnings. The skilled player 695 then records the earnings on the blockchain network 680 at step 607 to update the model record.

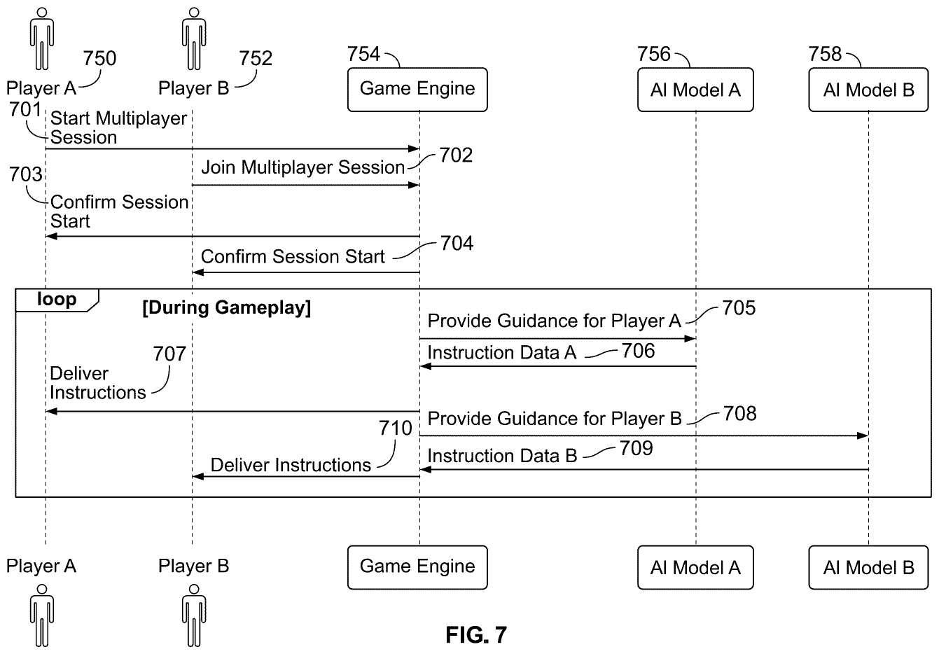

FIG. 7 shows an example workflow of a multiplayer gaming session using multiple AI models. At step 701, player A 750, a primary player, starts a multiplayer gaming session. Player A 750 may start a multiplayer gaming session, for example, through simply initializing a game or inviting others to play. Next, a second player, player B 752, another primary player, joins the multiplayer gaming session. The second player B 752 may join the game by, for example, selecting a link to the gaming session. The game engine 754 then confirms the gaming session start, for example through a notification to player A at step 703 and to player B at step 704.

During gameplay, the game engine 754 provides guidance to player A 750 using AI model A 756, as shown in step 705. The game engine 754 may in some embodiments select this model beforehand or select it based on an analysis of the performance of player A. In some embodiments, player A selects the model. In some multiplayer embodiments, the game engine 754 recommends importing an AI model trained on successful strategies employed by other teams or multiplayer groups. The AI model may enhance coordination and performance in cooperative gameplay as well.

At step 706, AI model A 756 returns instruction data A for player A 750 from AI model A 756 to game engine 754. The instruction data may be instructions similar to those seen in display 116 of FIG. 1. The game engine 754 then, at step 707, delivers the instructions to player A 750. The instructions may take forms described above such as a text notification. The gaming assistance system 100 may integrate assistance with in-game communication systems to relay instructions seamlessly to all team members.

The same process of AI model selection and instruction selection may be executed for player B 752 using AI model B 758. During gameplay, the game engine 754 provides guidance to player B 752 using AI model B 758, as shown in step 708. At step 709, AI model B 758 returns instruction data B for player B 752 from AI model B 758 to engine 754. The game engine 754 then, at step 710, delivers the instructions to player B 752, as discussed above in regard to that of Player A 750. Both players may then continue the gaming session with additional support.

In some embodiments, the two AI models may merge to create a team model. In some embodiments, the players, A and B, may use one group model in place of two separate models.

Groups may learn advanced tactics and coordination techniques using the additional support of the AI model or models. Group assistance may also enhance team coordination, such as suggesting strategies, positioning, and timing for collective actions. It should be noted that capturing and applying complex group dynamics in AI models may require advanced modeling techniques.

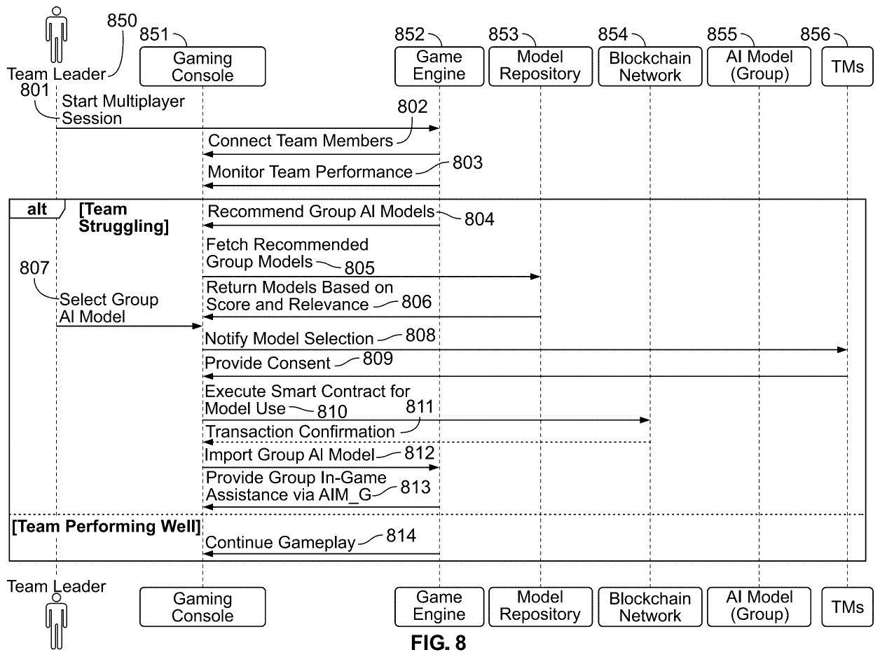

FIG. 8 shows an example workflow of model recommendation and importation into a gaming session in a group setting. At step 801, a team leader 850, such as a primary player, starts a multiplayer session by, for example, initializing a multiplayer game. In response, at step 802, a game engine 852 connects other team members through, for example, an internet connection, and monitors the team performance at step 803. The other team members may be other primary players, that is, users playing the game, for example. The game engine 852 may monitor the team performance based on available metrics such as rankings, points, time elapsed, and so on. The monitoring may be facilitated through an internet connection or other connection capable of retrieving gaming data.

When the gaming assistance system 100 detects that a team is struggling, that is, the metrics indicate a poor performance, the game engine 852 may recommend group AI models 855 via a gaming console 851 at step 804. The gaming console 851 may fetch the recommended group models from a model repository 853 at step 805. The model repository then, at step 806 may return models based on scores of the models and determined relevance. At step 807, the team leader 850 may select a group AI model 855 from the recommended models. The gaming console 851 may then, at 808, notify the team members (TMs) 856 of the model selection. After acting on the notification, the TMs 856 provide consent to use the group AI model 855 at step 809. In some embodiments, all team members are prompted to agree to use the AI model and trust its recommendations.

The gaming console 851 may then execute a smart contract for model use at step 810, and blockchain network 854, at step 811, confirms the contract transaction after assessing model records on the blockchain network 854. The gaming console 851 then, at 812, imports the group AI model into game engine 852. At 813, the gaming engine provides gaming console 851 group in-game assistance via the group AI model. In some embodiments, the gaming assistance system 100 ensure that all team members receive and act upon the guidance in a synchronized manner. When the team is performing well, as shown at step 814, the game engine 852 continues gameplay.

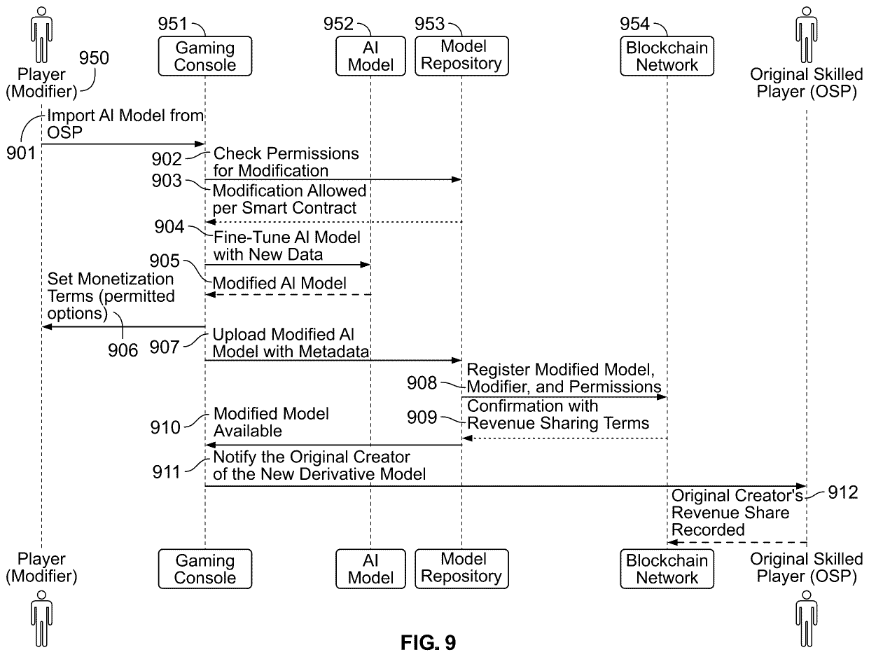

FIG. 9 shows an example workflow of model fine-tuning and redistribution. At step 901, a player 950, such as the primary player discussed in connection with FIG. 1, imports an AI model into gameplay. This importation may follow a selection of an AI model or may be automatic. The AI model, in some embodiments, has specified permissions for modification. An original creator may set these permissions and may record them on a model repository, such as repository 106, or within model metadata. The gaming console 951, then, at step 902, checks the permissions for modification of the AI model using the model repository 953.

At step 903, the model repository 953, upon receiving a request for a check and assessing its own records to confirm approval, informs the gaming console 951 that the modification is allowed per a smart contract. At step 904, the gaming console 951 then fine tunes the AI model 952 with new data. The gaming console 951 may fine tune the AI model 952 by, for example, uploading additional data into a training algorithm.

At step 905, the gaming console 951 then has a modified AI model and at step 906, sets monetization terms or permitted options for the modified AI model. In some embodiments the modified model includes metadata referencing the original model and creator. The gaming console 951 may specify who may receive payment for modified model use and under what conditions. The gaming console 951 may further record these terms in, for example, the model repository 953, as seen at step 907, where the gaming console 951 uploads the modified AI model with metadata into a model repository 953. The model repository then, at step 908, may register the modified model, modifier, and permissions with a blockchain network 954. In some embodiments, a smart contract on the blockchain network 954 defines how revenue is shared between the original creator and the modifier.

At step 909, the blockchain network 954 confirms that it has received and recorded revenue sharing terms on a network for reference. At step 910, the model repository 953 informs the gaming console 951 that the modified model is available. The gaming console 951 then, at step 911, notifies the original creator 960, such as a skilled player, of the modified model and its availability. The original creator 960 may then, if applicable, at step 912 record their revenue share on the blockchain network 954. In some embodiments, the gaming assistance system 100 automatically distributes revenue according to the agreed terms. In some embodiments, if the original skilled player (OSP) does not permit redistribution, the gaming assistance system 100 prevents the modified model from being shared further.

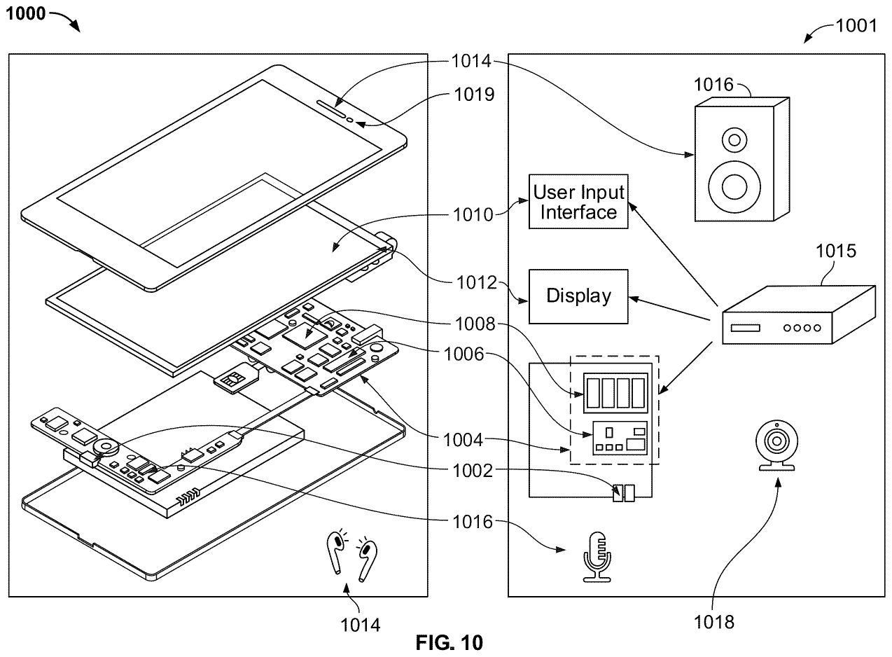

FIGS. 10-11 describe illustrative devices, systems, servers, and related hardware for extending selectable object capability to a captured image, in accordance with some embodiments of the present disclosure. In some embodiments, any suitable combination of the components of FIGS. 10-11 may be employed to perform the techniques described in FIGS. 1-9 and 12.

FIGS. 10-11 show illustrative devices, systems, servers, and related hardware for providing in-game assistance in a video game, in accordance with some embodiments of this disclosure. FIG. 10 shows generalized embodiments of illustrative computing devices 1000 and 1001, which may correspond to, e.g., a smart phone; a tablet; a laptop computer; a personal computer; a desktop computer; a smart television; a smart watch or wearable device; smart glasses; a stereoscopic display; a wearable camera; XR glasses; XR goggles; a stereoscopic display; XR glasses; an XR HMD; or any other suitable computing device; or any combination thereof. In another example, computing device 1001 may be a user television equipment system or device. In some embodiments, computing devices 1000 and 1001 may correspond to, e.g., user device 102.

User television equipment device 1001 may include set-top box 1015. In some embodiments, element 1015 may correspond to a video game console (e.g., Xbox, PlayStation, or any other suitable gaming console). Set-top box 1015 may be communicatively connected to microphone 1016, Audio output equipment (e.g., speaker or headphones 1014), and display 1012. In some embodiments, microphone 1016 may receive audio corresponding to a voice of a user providing input. In some embodiments, display 1012 may be a television display or a computer display. In some embodiments, set-top box 1015 may be communicatively connected to user input interface 1010. In some embodiments, user input interface 1010 may be a remote control device. Set-top box 1015 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 10. In some embodiments, computing device 1000 may comprise any suitable number of sensors (e.g., gyroscope or gyrometer, or accelerometer, etc.), and/or a GPS module (e.g., in communication with one or more servers and/or cell towers and/or satellites) to ascertain a location of computing device 1000. In some embodiments, computing device 1000 comprises a rechargeable battery that is configured to provide power to the components of the device.

Each one of computing device 1000 and computing device 1001 may receive content and data via input/output (I/O) path 1002. I/O path 1002 may provide content (e.g., broadcast programming, on-demand programming, Internet content, content available over a local area network (LAN) or wide area network (WAN), and/or other content) and data to control circuitry 1004, which may comprise processing circuitry 1006 and storage 1008. Control circuitry 1004 may be used to send and receive commands, requests, and other suitable data using I/O path 1002, which may comprise I/O circuitry. I/O path 1002 may connect control circuitry 1004 (and specifically processing circuitry 1006) to one or more communications paths (described below). I/O functions may be provided by one or more of these communications paths, but are shown as a single path in FIG. 10 to avoid overcomplicating the drawing. While set-top box 1015 is shown in FIG. 10 for illustration, any suitable computing device having processing circuitry, control circuitry, and storage may be used in accordance with the present disclosure. For example, set-top box 1015 may be replaced by, or complemented by, a personal computer (e.g., a notebook, a laptop, a desktop), a smartphone (e.g., computing device 1000), an XR device; a tablet; a network-based server hosting a user-accessible client device; a non-user-owned device; any other suitable device; or any combination thereof.

Control circuitry 1004 may be based on any suitable control circuitry such as processing circuitry 1006. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1004 executes instructions for the gaming assistance system 100 stored in memory (e.g., storage 1008). Specifically, control circuitry 1004 may be instructed by the gaming assistance system 100 to perform the functions discussed above and below. In some implementations, processing or actions performed by control circuitry 1004 may be based on instructions received from the gaming assistance system 100.

In client/server-based embodiments, control circuitry 1004 may include communications circuitry suitable for communicating with a server or other networks or servers. The gaming assistance system 100 may be a stand-alone application implemented on a device or a server. The gaming assistance system 100 may be implemented as software or a set of executable instructions. The instructions for performing any of the embodiments discussed herein of the gaming assistance system 100 may be encoded on non-transitory computer-readable media (e.g., a hard drive, random-access memory on a DRAM integrated circuit, read-only memory on a BLU-RAY disk, etc.). For example, in FIGS. 1A-1B, the instructions may be stored in storage 1008, and executed by control circuitry 1004 of a device 1000.

In some embodiments, the gaming assistance system 100 may be a client/server application where only the client application resides on a device (e.g., user device 102), and a server application resides on an external server (e.g., server 1004). For example, the gaming assistance system 100 may be implemented partially as a client application on control circuitry 1004 of device 1000 and partially on server 1104 as a server application running on control circuitry 1113. Server 1104 may be a part of a local area network with one or more of devices 1000, 1001 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 1104 and/or an edge computing device), referred to as “the cloud.”

Device 1000 may be a cloud client that relies on the cloud computing capabilities from server 1104 to determine whether processing (e.g., at least a portion of virtual background processing and/or at least a portion of other processing tasks) should be offloaded from the mobile device, and facilitate such offloading. When executed by control circuitry of server 1104, the gaming assistance system 100 may instruct control circuitry 1111 to perform processing tasks for the client device and facilitate the generation of encoding data. The client application may instruct control circuitry 1004 to determine whether processing should be offloaded.

Control circuitry 1004 may include communications circuitry suitable for communicating with a server, edge computing systems and devices, a table or database server, or other networks or servers The instructions for carrying out the above mentioned functionality may be stored on a server (which is described in more detail in connection with FIG. 11. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 11). In addition, communications circuitry may include circuitry that enables peer-to-peer communication of computing devices, or communication of computing devices in locations remote from each other (described in more detail below).

Memory may be an electronic storage device provided as storage 1008 that is part of control circuitry 1004. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1008 may be used to store various types of content described herein as well as the gaming assistance system 100 data described above. Nonvolatile memory may also be used (e.g., to launch a boot-up routine and other instructions). Cloud-based storage, described in more detail in relation to FIG. 11, may be used to supplement storage 1008 or instead of storage 1008.

Control circuitry 1004 may include video generating circuitry and tuning circuitry, such as one or more analog tuners, or HEVC decoders or any other suitable digital decoding circuitry, high-definition tuners, or any other suitable tuning or video circuits or combinations of such circuits. Encoding circuitry (e.g., for converting over-the-air, analog, or digital signals to SHVC or any other suitable signals for storage) may also be provided. Control circuitry 1004 may also include scaler circuitry for upconverting and down converting content into the preferred output format of computing device 1000. Control circuitry 1004 may also include digital-to-analog converter circuitry and analog-to-digital converter circuitry for converting between digital and analog signals. The tuning and encoding circuitry may be used by computing device 1000, 1001 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1008 is provided as a separate device from computing device 1000, the tuning and encoding circuitry (including multiple tuners) may be associated with storage 1008.

Control circuitry 1004 may receive instruction from a user by way of user input interface 1010. User input interface 1010 may be any suitable user interface, such as a remote control, mouse, trackball, keypad, keyboard, touch screen, touchpad, stylus input, joystick, voice recognition interface, or other user input interfaces. Display 1012 may be provided as a stand-alone device or integrated with other elements of each one of computing device 1000 and computing device 1001. For example, display 1012 may be a touchscreen or touch-sensitive display. In such circumstances, user input interface 1010 may be integrated with or combined with display 1012. In some embodiments, user input interface 1010 includes a remote-control device having one or more microphones, buttons, keypads, any other components configured to receive user input or combinations thereof. For example, user input interface 1010 may include a handheld remote-control device having an alphanumeric keypad and option buttons. In a further example, user input interface 1010 may include a handheld remote-control device having a microphone and control circuitry configured to receive and identify voice commands and transmit information to set-top box 1015.

Audio output equipment 1014 may be integrated with or combined with display 1012.

Display 1012 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1012. Audio output equipment 1014 may be provided as integrated with other elements of each one of computing device 1000 and computing device 1001 or may be stand-alone units. An audio component of videos and other content displayed on display 1012 may be played through speakers (or headphones) of audio output equipment 1014. In some embodiments, audio may be distributed to a receiver (not shown), which processes and outputs the audio via speakers of audio output equipment 1014. In some embodiments, for example, control circuitry 1004 is configured to provide audio cues to a user, or other audio feedback to a user, using speakers of audio output equipment 1014. There may be a separate microphone 1016 or audio output equipment 1014 may include a microphone configured to receive audio input such as voice commands or speech. For example, a user may speak letters or words or terms or numbers that are received by the microphone and converted to text by control circuitry 1004. In a further example, a user may voice commands that are received by a microphone and recognized by control circuitry 1004. Camera 1018 may be any suitable video camera integrated with the equipment or externally connected. Camera 1018 may be a digital camera comprising a charge-coupled device (CCD) and/or a complementary metal-oxide semiconductor (CMOS) image sensor. Camera 1018 may be an analog camera that converts to digital images via a video card.

The gaming assistance system 100 may be implemented using any suitable architecture. For example, it may be a stand-alone application wholly-implemented on each one of computing device 1000 and computing device 1001. In such an approach, instructions of the application may be stored locally (e.g., in storage 1008), and data for use by the application is downloaded on a periodic basis (e.g., from an out-of-band feed, from an Internet resource, or using another suitable approach). Control circuitry 1004 may retrieve instructions of the application from storage 1008 and process the instructions to provide video conferencing functionality and generate any of the displays discussed herein. Based on the processed instructions, control circuitry 1004 may determine what action to perform when input is received from user input interface 1010. For example, movement of a cursor on a display up/down may be indicated by the processed instructions when user input interface 1010 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1004 may allow a user to provide user profile information or may automatically compile user profile information. For example, control circuitry 1004 may access and monitor network data, video data, audio data, processing data, participation data from a conference participant profile. Control circuitry 1004 may obtain all or part of other user profiles that are related to a particular user (e.g., via social media networks), and/or obtain information about the user from other sources that control circuitry 1004 may access. As a result, a user can be provided with a unified experience across the user's different devices.

In some embodiments, the gaming assistance system 100 is or comprises a client/server-based application. Data for use by a thick or thin client implemented on each one of computing device 1000 and computing device 1001 may be retrieved on-demand by issuing requests to a server remote to each one of computing device 1000 and computing device 1001. For example, the remote server may store the instructions for the application in a storage device. The remote server may process the stored instructions using circuitry (e.g., control circuitry 1004) and generate the displays discussed above and below. The client device may receive the displays generated by the remote server and may display the content of the displays locally on computing device 1000. This way, the processing of the instructions is performed remotely by the server while the resulting displays (e.g., that may include text, a keyboard, or other visuals) are provided locally on computing device 1000. Computing device 1000 may receive inputs from the user via input interface 1010 and transmit those inputs to the remote server for processing and generating the corresponding displays. For example, computing device 1000 may transmit a communication to the remote server indicating that an up/down button was selected via input interface 1010. The remote server may process instructions in accordance with that input and generate a display of the application corresponding to the input (e.g., a display that moves a cursor up/down). The generated display is then transmitted to computing device 1000 for presentation to the user.

In some embodiments, the gaming assistance system 100 may be downloaded and interpreted or otherwise run by an interpreter or virtual machine (run by control circuitry 1004). In some embodiments, the gaming assistance system 100 may be encoded in the ETV Binary Interchange Format (EBIF), received by control circuitry 1004 as part of a suitable feed, and interpreted by a user agent running on control circuitry 1004. For example, the gaming assistance system 100 may be an EBIF application. In some embodiments, the gaming assistance system 100 may be defined by a series of JAVA-based files that are received and run by a local virtual machine or other suitable middleware executed by control circuitry 1004. In some of such embodiments (e.g., those employing H.265, SHVC or any other suitable digital media encoding schemes), the gaming assistance system 100 may be, for example, encoded and transmitted in using an SHVC with the SHVC audio and video packets of a program.

FIG. 11 is a diagram of an illustrative system 1100, in accordance with some embodiments of this disclosure. Computing devices 1107, 1108, 1110 (which may correspond to, e.g., computing device 1000 or 1001) may be coupled to communication network 1109. Communication network 1109 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1109) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 11 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 602-11x, etc.), or other short-range communication via wired or wireless paths. The computing devices may also communicate with each other directly through an indirect path via communication network 1109.

System 1100 may comprise media content source 1102, one or more servers 1104, and/or one or more edge computing devices. In some embodiments, the gaming assistance system 100 may be executed at one or more of control circuitry 1113 of server 1104 (and/or control circuitry of computing devices 1107, 1108, 1110 and/or control circuitry of one or more edge computing devices). In some embodiments, the media content source and/or server 1104 may be configured to host or otherwise facilitate video communication sessions between computing devices 1107, 1108, 1110 and/or any other suitable computing devices, and/or host or otherwise be in communication (e.g., over network 1109) with one or more social network services.

In some embodiments, server 1104 may include control circuitry 1113 and storage 1114 (e.g., RAM, ROM, Hard Disk, Removable Disk, etc.). Storage 1114 may store one or more databases. Server 1104 may also include an input/output path 1112. I/O path 1112 may provide video conferencing data, device information, or other data, over a local area network (LAN) or wide area network (WAN), and/or other content and data to control circuitry 1113, which may include processing circuitry, and storage 1114. Control circuitry 1113 may be used to send and receive commands, requests, and other suitable data using I/O path 1112, which may comprise I/O circuitry. I/O path 1112 may connect control circuitry 1113 (and specifically control circuitry) to one or more communications paths.

Control circuitry 1113 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1113 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1113 executes instructions for an emulation system application stored in memory (e.g., the storage 1114). Memory may be an electronic storage device provided as storage 1114 that is part of control circuitry 1113.

In some embodiments, server 1104 may be included in a CDN, which may include origin servers, data centers, central servers, and/or edge servers, and/or any other suitable components. Computing devices 1107, 1108, 1110 may comprise one or more decoders, which may comprise any suitable combination of hardware and/or software configured to convert data in a coded form to a form that is usable as video signals and/or audio signals or any other suitable type of data signal, or any combination thereof. The encoder may comprise any suitable combination of hardware and/or software configured to process data to reduce storage space required to store the data and/or bandwidth required to transmit the image data, while minimizing the impact of the encoding on the quality of the video or one or more images. The encoder and/or decoder may utilize any suitable algorithms and/or compression standards and/or codecs. In some embodiments, the encoder and/or decoder may be a virtual machine that may reside on one or more physical servers that may or may not have specialized hardware, and/or a cloud service may determine how many of these virtual machines to use based on established thresholds. In some embodiments, separate audio and video encoders and/or decoders may be employed.

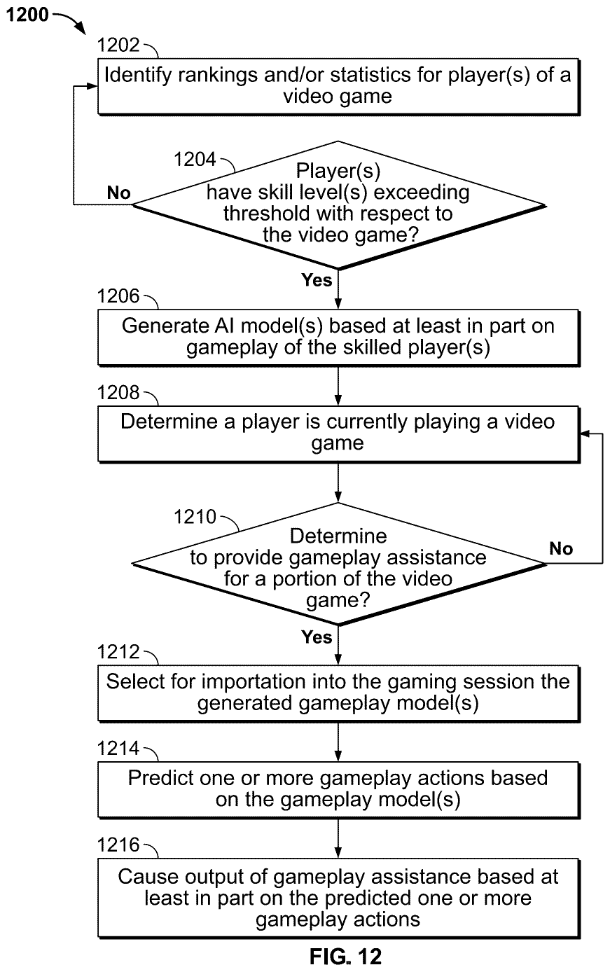

FIG. 12 shows an illustrative flowchart of a process 1200 for importing gameplay assistance based on a gameplay performance, in accordance with some embodiments of this disclosure. In various embodiments, the individual steps of process 1200 may be implemented by one or more components of the devices, methods, and systems of FIGS. 1-11 and may be performed in combination with any of the other processes and aspects described herein. Although the present disclosure may describe certain steps of processes 1200 (and of other processes described herein) as being implemented by certain components of the devices, methods, and systems of FIGS. 1-11, this is for purposes of illustration only, and it should be understood that other components of the devices, methods, and systems of FIGS. 1-11 may implement those steps instead.

In process 1200, at step 1202, control circuitry (e.g., control circuitry 1004 of computing device 1000 of FIG. 10 and/or control circuitry 1111 of server 1104 of FIG. 11) may identify rankings and/or statistics for player(s) of a video game. Based on such data and/or any other suitable data, the control circuitry may determine whether one or more of such players exceed a threshold skill level with respect to the video game, at 1204. For example, the control circuitry may identify players for a video game (e.g., video game 101 of FIG. 1) at the top of a leaderboard or at least a threshold position on the leaderboard, having played the video game for at least a threshold number of hours or having completed at least a threshold number of tasks with the video game, having a certain number of followers or certain reputation score among peers (e.g., on Twitch), and/or using any other suitable criteria. If a player has a skill level below a threshold, such player may not be prompted for permission to use their gameplay to generate an AI model.

At 1206, having identified one or more skilled players having a skill level above a threshold, the control circuitry may generate an AI model based at least in part on gameplay of the respective one or more players. For example, the control circuitry may generate an AI model (e.g., gameplay model 202 of FIGS. 2A-2B) for such skilled players, e.g., skilled player models 103, 105, 107, and 109. Such models may be generated at varying times, e.g., upon a particular player's skill exceeding a threshold. In some embodiments, a skilled player may receive an invitation to create an AI model upon the skilled player's gameplay statistics, and the AI model may be generated upon receiving the skilled player's approval. Alternatively, an AI model may be automatically created based at least in part on such skilled player's gameplay, e.g., based on the skilled player opting into a privacy policy for video game 101 when initially playing the video game.

At 1208, the control circuitry may determine that a player (e.g., user 111 of FIG. 1) is playing a video game. For example, the player at 1208 may be a different player from the one or more players indicated at 1202 and 1204, the gameplay of whom respective AI models may be generated. For example, in some embodiments, the player at 1208 may be an average or below average gamer, e.g., not having a skill level above a threshold skill level. In some embodiments, a server may receive an indication from a gaming console of the player that a user is playing the video game, and/or the server may be providing the video game session to the player's user device (e.g., user device 102 of FIG. 1). In some embodiments, video game monitoring, game console status, or other input may be used to determine that the video game is currently being played.

At 1210, the control circuitry may determine whether or not to provide gameplay assistance to the player (e.g., user 111 of FIG. 1) playing the video game (e.g., video game 101 of FIG. 1), in relation to a portion of the video game (e.g., the next move in the chess video game). For example, the portion of the video game may be a portion the user is currently playing, or an upcoming portion (e.g., a next level the user is likely to play within a threshold period time, e.g., five minutes from a current time). In some embodiments, an affirmative determination at 1210 may be based on the player (e.g., user 111) having failed at a specific level or task at least a threshold number of times (e.g., five times) or having been stuck on a certain level or task for more than a threshold period of time, which may vary based on a video game being played and/or a task within the video game. As another example, an affirmative determination at 1210 may be based on the player (e.g., user 111) having a win probability (e.g., based on the current arrangement of remaining pieces on the chess board) below a threshold.

As another example, an affirmative determination at 1210 may be based on gameplay performance as detected through gameplay monitoring. For example, control circuitry may detect, through monitoring gameplay, that the first player has repeated a level without completion past a given threshold number of attempts. This information may indicate that the player is having difficulty and would benefit from assistance. In response to this detection, the control circuitry may determine to provide assistance that will help the first player complete the level.

An affirmative determination at 1210 may cause processing to proceed to 1212; otherwise, processing may revert to 1208, where the control circuitry may continue monitoring the gameplay of user 111, e.g., for current or upcoming portions of the video game for which the user may be provided with in-game assistance.

At 1212, the control circuitry may select for importation, into the gaming session (for the video game being played by the user indicated at 1208), the gameplay model(s) generated at 1206. For example, in FIG. 1, skilled player model 107 may be selected, based on being a highest-ranked AI model for video game 101 being played, and/or based on being aligned with interests or strategies indicated by historical gameplay data of user 111 playing video game 101 in the gaming session. In some embodiments, such gameplay model(s) may be imported based on receiving approval from user 111 (e.g., in real time, or based on previously received preferences input for receiving such recommendations), or may be imported automatically.

At 1214, the control circuitry may predict one or more gameplay actions based on the gameplay model(s). For example, the selected AI model may, as shown in FIG. 2, receive input of the current or upcoming portion of the video game being played by user 111, to obtain a synchronized game state, and may output such predicted one or more gameplay actions. In some embodiments, the one or more gameplay actions predicted at 1214 may be based at least in part on inputs predicted to be received from a skilled user corresponding to the gameplay model, e.g., if the same portion of the video game was being played by the second user (the skilled player). For example, the control circuitry may, using the gameplay model, predict that at the given portion of the video game, the skilled user would likely select a specific tool based on collected input from the skilled player at the same point in the video game or other similar points in the video game.

At step 1216, while the video game is being played by the first user, the control circuitry may cause output of gameplay assistance based at least in part on the predicted one or more gameplay actions, such as seen in display 116 of FIG. 1. The output may include instructions or recommendations for suggested actions the user may take to improve game performance. The output may take any suitable form, such as a video recommendation, text instructions, audio instructions, or any suitable combination thereof. For example, using the action predicted at the previous step, the control circuitry may display a notice recommending that the first user perform the predicted action. For instance, in the example above, the control circuitry may display a recommendation that the first user select the tool the skilled player is most likely to select at that point in the video game.

In some embodiments, while user 111 is being provided with gameplay assistance (or throughout a session in which assistance is requested), achievements by user 111 may not be counted (or may be weighted lower than if assistance was not requested) towards an assessment of a skill level which would allow user 111 to be considered a skilled player for the purposes of generating an AI model based on user 111's gameplay. In some embodiments, gameplay during which assistance (or throughout a session in which assistance is requested) may not be used for training data for generating an AI model, or may be weighted lower in training a model, if a player having a skill level exceeding a threshold has previously requested and received in-game assistance.

The processes discussed above and below are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any some embodiments, may be applied to any other embodiment herein, and flowcharts or examples relating to some embodiments, may be combined with any other embodiment in a suitable manner, done in different orders, or done in parallel. In addition, the systems, methods, apparatuses, and computer-readable media described herein may be performed in real time or near real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A computer-implemented method comprising:
while a video game is being played by a first user during a gaming session, determining to provide gameplay assistance to the first user for a portion of the video game;
based at least in part on the determining, selecting for importation into the gaming session a gameplay model, wherein the gameplay model is generated based at least in part on gameplay of a second user determined to have a skill level above a threshold with respect to the video game;
importing the gameplay model into the gaming session;
predicting one or more gameplay actions based at least in part on the gameplay model; and
while the video game is being played by the first user, causing output of gameplay assistance based at least in part on the predicted one or more gameplay actions.

2. The method of claim 1, further comprising, prior to the determining to provide the gameplay assistance to the first user:
determining the second user has a skill level above the threshold with respect to the video game based at least in part on receiving data regarding gameplay of the second user with respect to the video game; and
generating the gameplay model by causing training of a machine learning model using the received data.

3. The method of claim 2, further comprising:
obtaining the predicted one or more gameplay actions for the portion of the video game based at least in part on inputting an indication of a current state of the video game being played by the first user to the trained machine learning model.

4. The method of claim 3, further comprising:
determining, after causing the output of the gameplay assistance, that one or more inputs received from the first user playing the portion of the video game do not match the one or more inputs associated with the predicted one or more gameplay actions of the second user; and
identifying an updated state of the video game based at least in part on the one or more inputs received from the first user; and
obtaining a new predicted gameplay action based at least in part on inputting an indication of the updated state of the video game being played by the first user to the trained machine learning model.

5. The method of claim 1, wherein:
using the imported gameplay model to predict one or more gameplay actions further comprises:
identifying a plurality of candidate predicted gameplay actions;
ranking the plurality of candidate gameplay actions based at least in part on similarity to historical actions of the first user with respect to the video game; and
identifying the highest ranked one or more gameplay actions as the one or more gameplay actions.

6. The method of claim 1, further comprising:
identifying a plurality of gameplay models as candidates for importation into the gaming session;
ranking the plurality of gameplay models in relation to the portion of the video game based at least in part on scores for the plurality of gameplay models; and
selecting the gameplay model for importation from the ranked plurality of gameplay models.

7. The method of claim 1, wherein the gameplay model comprises a generative artificial intelligence (AI) model, the method further comprising:
using the generative AI model to output the gameplay assistance in a voice of the second user.

8. The method of claim 1, wherein:
determining to provide gameplay assistance to the first user for the portion of the video game is performed based on a prediction, prior to the gaming session corresponding to the portion of the video game, that the gaming session is likely to correspond to the portion of the video game within at a later time that is within a threshold period of time from a current time; and
importing the gameplay model is preemptively performed prior to the later time.

9. The method of claim 1, further comprising:
identifying a permission associated with the gameplay model;
determining whether the permission indicates that the first user is permitted to modify the gameplay model based at least in part on gameplay of the first user in relation to the video game; and
based at least in part on determining the permission permits the first user to modify the gameplay model, fine-tuning the gameplay model based at least in part on gameplay of the first user.

10. The method of claim 9, wherein the permission is stored on a distributed ledger defining restrictions on modification or redistribution for a plurality of gameplay models.

11. The method of claim 1, further comprising:
determining whether the gameplay assistance matches one or more inputs received from the first user when the gaming session corresponds to the portion of the video game;
determining a level of success of the gameplay assistance; and
updating the gameplay model based at least in part on the success of the gameplay assistance.

12. The method of claim 1, further comprising aggregating at least two gameplay models to create a multiplayer gameplay model, and wherein the gaming session comprises at least one additional user other than the first user.

13. The method of claim 1, wherein the gameplay model is trained using data from one or more multi-player gaming sessions of the video game, and wherein the gaming session is a multi-player gaming session.

14. The method of claim 1, wherein while the gameplay assistance is being provided to the first user, gameplay of the first user is not counted towards an assessment of a skill level of the first user, wherein the skill level of the first user is less than the threshold with respect to the video game.

15. A system comprising:
control circuitry configured to:
while a video game is being played by a first user during a gaming session, determine to provide gameplay assistance to the first user for a portion of the video game;
based at least in part on the determining, select for importation into the gaming session a gameplay model, wherein the gameplay model is generated based at least in part on gameplay of a second user determined to have a skill level above a threshold with respect to the video game;
import the gameplay model into the gaming session;
predict one or more gameplay actions based at least in part on the gameplay model; and
while the video game is being played by the first user, cause output of gameplay assistance based at least in part on the predicted one or more gameplay actions.

16. The system of claim 15, wherein the control circuitry is further configured to, prior to the determining to provide the gameplay assistance to the first user:
determine the second user has a skill level above the threshold with respect to the video game based at least in part on receiving data regarding gameplay of the second user with respect to the video game; and
generate the gameplay model by causing training of a machine learning model using the received data.

17. The system of claim 16, wherein the control circuitry is further configured to:
obtain the predicted one or more gameplay actions for the portion of the video game based at least in part on inputting an indication of a current state of the video game being played by the first user to the trained machine learning model.

18. The system of claim 17, wherein the control circuitry is further configured to:
determine, after causing the output of the gameplay assistance, that one or more inputs received from the first user playing the portion of the video game do not match the one or more inputs associated with the predicted one or more gameplay actions of the second user; and
identify an updated state of the video game based at least in part on the one or more inputs received from the first user; and
obtain a new predicted gameplay action based at least in part on inputting an indication of the updated state of the video game being played by the first user to the trained machine learning model.

19. The system of claim 15, wherein the control circuitry is further configured to:
use the imported gameplay model to predict one or more gameplay actions by:
identifying a plurality of candidate predicted gameplay actions;
ranking the plurality of candidate gameplay actions based at least in part on similarity to historical actions of the first user with respect to the video game; and
identifying the highest ranked one or more gameplay actions as the one or more gameplay actions.

20. The system of claim 15, wherein the control circuitry is further configured to:
identify a plurality of gameplay models as candidates for importation into the gaming session;
rank the plurality of gameplay models in relation to the portion of the video game based at least in part on scores for the plurality of gameplay models; and
select the gameplay model for importation from the ranked plurality of gameplay models.

21-70. (canceled)
